(19) United States
(12) Patent Application Publication
(10) Pub. No.: US 2003/0147716 A1
(43) Pub. Date: Aug. 7, 2003

(54) Structure of loosening-stop tightening means, loosening-stop bolt having the structure, method for producing the same bolt, loosening-stop nut having the structure, and method for producing the same nut

(75) Inventors: Masato Nagawa, Kitakyushu-shi (JP); Hideki Noda, Kitakyushu-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: DAIKI INDUSTRIES CO., LTD., Kitakyushu-shi (JP)

(21) Appl. No.: 10/268,993

(22) Filed: Oct. 11, 2002

(30) Foreign Application Priority Data
Feb. 1, 2002 (JP) 2002-26183
Apr. 10, 2002 (JP) 2002-108374
Apr. 10, 2002 (JP) 2002-108375

(51) Int. Cl. F16B 39/22

(52) U.S. Cl. 411/288

(57) ABSTRACT

The invention provides a structure of a loosening-stop tightening means, a loosening-stop bolt having the structure, a method for producing the same bolt, a loosening-stop nut having the structure, and a method for producing the same nut, by which the screwing force can be prevented from being lowered when an external force is applied to a member to be tightened and a screw thread, etc., and a high tightening force can be semi-permanently maintained, wherein the structure for a loosening-stop tightening means according to the invention is a structure for a loosening-stop tightening means that is screwed in or to a screw thread and tightens a member to be tightened, and the structure comprises a tightening body, a main screw thread portion formed on the tightening body, and a sub screw thread portion spaced from the main screw thread portion by an annular groove portion and formed coaxially with the main screw thread portion, whose phase with respect to the main screw thread portion is displaced by 12° through 100°, preferably 24° through 60°.

### BACKGROUND OF THE INVENTION

1. Field of the invention

The present invention relates to a structure of a loosening-stop tightening means such as a loosening stop bolt and a loosening-stop nut, a loosening-stop nut employing the structure, a method for producing the same nut, and a loosening stop bolt, and a method for producing the same loosening-stop bolt, which is screwed to a screw thread and tightens a member to be tightened, and at the same time, prevents the screwing force and tightening force from being lowered when an external force such as vibrations is applied to the member or screw thread.

2. Prior Art

Conventionally, tightening means such as bolts and nuts have been frequently used to tighten various types of parts in transportation means such vehicles, aircraft, electric tramcars, etc., various types of industrial machines and apparatuses, transfer pipelines, power transmission apparatuses, etc., and occupy a very important part as mechanical elements used for tightening.

However, trouble such as loosening of a tightened portion of a member to be tightened or slipping off of tightening means due to a lowering of a screwing force and a tightening force resulting from loosening of a screw tightening means by external forces such as vibrations applied to the member to be tightened and tightening means has frequently occurred as known previously. Therefore, it has been desired to increase safety wherein a bolt and a nut which do not slacken or loosen even if some external force such as vibrations are applied thereto are included.

Therefore, recently, various types of loosening-stop bolts and loosening-stop nuts have been developed in order to prevent bolts and nuts from being loosened from screw threads thereof. In particular, various types of tightening means are disclosed as loosening-stop bolts in Japanese Unexamined Patent Publication Nos. 37114 of 1982, 109915 of 1996, 280239 of 1997, 37130 of 1999, Japanese Unexamined Utility Model Publication Nos. 89016 of 1983, 69517 of 1987, etc. These bolts are such that a turn-stop portion is formed on the flank and bearing surface of a screw thread to deform the screw thread in order to increase the friction force thereof, wherein once such bolts are tightened and screwed in, it is very difficult to remove the bolts, and repeated use thereof is not preferable.

As a loosening-stop bolt that can be repeatedly used, for example, a loosening-stop bolt is disclosed in Japanese Unexamined Utility Model Publication No. 36116 of 1992 (hereinafter called Publication“a”). That is, the utility model discloses a loosening-stop bolt comprising: a main bolt; a variable screw thread having a male screw thread formed at the same diameter and pitch as those of a screw thread portion at the axial end of the end portion of the bolt and unrotatably disposed movably in the axial direction; and an adjusting axis inserted into the axial center portion of the main bolt and the variable screw thread and freely causing the variable screw thread to be drawn near and be separated from the screw thread portion of the main bolt in the axial direction by being turned clockwise or counterclockwise in the axial direction with respect to the screw thread portion of the main bolt.

Further, as a loosening-stop nut, a nut is disclosed in Japanese Patent Publication No. 26851 of 1987 (hereinafter called Publication“b”). That is, the invention discloses a method for producing a loosening-stop nut comprising: an annular recessed portion formed to have a larger diameter than the root diameter of a female screw thread on the inner circumferential surface having a female screw thread between both end faces in the axial direction; a first female screw thread and a second female screw thread, which are sectioned by the annular recessed portion; an annular groove formed to have a larger diameter than the root diameter of a female screw thread on one end face of both the end faces; a central portion and a peripheral portion, which are sectioned by the annular groove; wherein the phases of the first female screw thread and second female screw thread slips by relatively shifting the central portion by one-third to one-half pitches of the female screw thread in the axial direction with respect to the peripheral portion.

However, the above-described conventional arts include the following shortcomings and problems.

(1) As regards the art disclosed in Publication “a”, since the art has a number of components, the structure is complicated, wherein the production thereof requires a number of processes, and productivity is not satisfactory.

(2) Since the art has a number of components and has many screw threads to be screwed, the screw thread surface is easily subjected to scuffing or wearing, and is finally subjected to damage.

(3) When the variable screw thread is pressed outward in the axial direction by turning the adjusting axis in a prescribed direction, the variable screw thread is separated from the screw thread portion of the main bolt, the screw thread portion and the flank of the variable screw thread are brought into contact with the flank of the female screw thread to stop loosening. However, the screw thread portion by which the adjusting axis is screwed with the variable screw thread is liable to loosen. If the screw thread portion is loosened, a force with which the female screw thread is pressed by the screw thread portion and variable screw thread is weakened. As a result, the main bolt is liable to be loosened.

(4) When carrying out a tightening operation, unless the variable screw thread is pressed outwardly in the axial direction by turning the adjusting axis in a prescribed direction after the main bolt is tightened in the female screw thread, no loosening-stop can be achieved. A number of operation processes are required, and tightening efficiency is not satisfactory.

(5) Since a very large force is required by a loosening-stop mechanism when being screwed in, ridges of the female screw thread are damaged.

(6) With respect to the art disclosed in Publication“b”, since the first female screw thread is formed so as to slip by ⅓ through ½ pitches of the second female screw thread, torque for tightening the screw thread portion of a loosening-stop nut in the screw thread portion of the bolt is increased to cause the tightening work to become difficult, wherein work efficiency is remarkably worsened. Also, a force necessary to tighten is increased, wherein tightening efficiency is worsened, and the screw thread portion of a loosening-stop nut and bolt is impaired when tightening, and seizing occurs in use, wherein repeated use thereof is unsatisfactory. In addition, since some nuts and bolts have unevenness in pitch and angle of the screw thread portion, contacting of the flanks becomes insufficient when being tightened, wherein no planned torque can be obtained, sufficient tightening is not achieved, and stability is insufficient.

The invention was developed to solve the above-described shortcomings and problems of the conventional arts, and it is therefore an object to provide a structure of a loosening-stop tightening means for a loosening-stop bolt and a loosening-stop nut, which is able to prevent a screwing force from being lowered when an external force is applied to a member to be tightened, is able to semi-permanently maintain a high screwing force, and is able to remarkably increase safety of a tightened part of the member to be tightened.

Also, it is another object of the invention to provide a loosening-stopbolt, which has a simple structure and excellent productivity, is able to prevent the screwing force thereof from being lowered when an external force is applied to a member to be tightened and a nut, is able to semi-permanently maintain a high tightening force, to remarkably increase safety of a tightened part of the member to be tightened, and is excellent in tightening efficiency and repeated use.

In addition, it is still another object of the invention to provide a method for producing a loosening-stop bolt, which is simple in work, has excellent operational efficiency and reliability.

Also, it is a further object of the invention to provide a loosening-stop nut, which has a simple structure and excellent productivity, is able to prevent the screwing force thereof from being lowered when an external force is applied to a member to be tightened and a bolt, is able to semi-permanently maintain a high tightening force, to remarkably increase safety of a tightened part of the member to be tightened, and is excellent in tightening efficiency and repeated use.

In addition, it is still a further object of the invention to provide a method for producing a loosening-stop nut, which is simple in work, has excellent operational efficiency and reliability.

### SUMMARY OF THE INVENTION

In order to solve the above-described shortcomings and problems, a structure of a loosening-stop tightening means, a loosening-stop bolt having the structure, a method for producing the same bolt, a loosening-stop nut having the structure, and a method for producing the same nut according to the invention have the following constructions.

A structure of a loosening-stop tightening means according to the first aspect of the invention is a structure of a loosening-stop tightening means for a loosening-stop bolt and a loosening-stop nut, which is screwed in a screw thread and tightens a member to be tightened, which comprises tightening means; a main screw thread portion formed on the above-described tightening means; and a sub screw thread portion, formed coaxially with the above-described main screw thread portion, whose phase with respect to the above-described main screw thread portion is displaced by 12 through 100°, preferably 24 through 90° or further preferably 24 through 72°.

With such a construction, the following actions can be brought about.

(1) Since loosening-stop tightening means which is screwed in a screw thread is such that the phase of the sub screw thread portion with respect to the main screw thread portion is displaced by a prescribed amount, it is because the direction along which the flank of the main screw thread portion is brought into contact with the flank of a screw thread due to contact pressure produced by the tightening force differs by 180° from the direction along which the flank of the sub screw thread portion is brought into contact with the flank of a screw thread. That is, the directions run counter to each other. Therefore, the direction of a torque produced by the contact pressure and lead angle of the screw thread at the main screw thread portion differs in terms of plus and minus from the direction thereof at the sub screw thread portion, wherein if an external force such as vibrations is applied to a screw thread and a member to be tightened, and a force operating along the turning direction along which the main screw thread portion is likely to be loosened from the screw thread is added, a torque produced at the flank of the sub screw thread portion operates in the tightening direction. Accordingly, it is possible to securely prevent the loosening-stop tightening means from being loosened from the screw threads, and a high tightening force can be semi-permanently maintained.

Herein, a male screw thread and a female screw thread may be used as a screw thread.

A sub male screw thread portion and a sub female screw thread portion, which are formed with the same pitch as that of the main screw thread portion of the main male screw thread portion and main female screw thread portion, may be used as the sub screw thread portion.

It is considered that such a tendency is brought about, by which the resilient displacement amount is decreased due to play by unevenness in machining accuracy of a screw thread and the main screw thread portion, etc., in line with the phase of the sub screw thread portion with respect to the main screw thread portion becoming smaller than 24°, wherein a reaction force obtained at a screw thread by the main screw thread portion and sub screw thread portion is small, and the screwing force of the screw thread is lowered. In addition, if the phase becomes 72° through 90°, torque before tightening (that is, free torque) is increased, wherein work efficiency is lowered, and seizing is liable to occur in use. Where the phase exceeds 90°, the main screw thread portion and sub screw thread portion are likely to be brought into sticky contact with the screw threads when tightening, and a force necessary to tighten is increased, wherein work efficiency is worsened. And, the main screw thread portion and sub screw thread portion are liable to be impaired, wherein repeated use becomes unsatisfactory. In particular, if the phase of the sub screw thread portion with respect to the main screw thread portion becomes smaller than 12° or exceeds 100°, the above-described tendencies become remarkable. Neither of the above is preferable.

Also, the phase of the sub screw thread portion may be displaced in either of the main screw thread portion side or the opposite side of the main screw thread portion. In either case, the direction along which the flank of the main screw thread portion presses the flank of a screw thread due to contact pressure produced when tightening may be made different by 180° from the direction along which the flank of the sub screw thread portion presses the flank of a screw thread.

It is preferable that an annular groove portion, which separates the main screw thread portion and sub screw thread portion from each other, is formed with the same depth as the root of the main screw thread portion or a depth deeper than the root diameter thereof between the main screw thread portion and the sub screw thread portion. It is possible to smoothly screw the main screw thread portion and sub screw thread portion in a screw thread without being caught when screwing these. A bolt-annular groove portion or a nut-annular groove portion, which is formed to be annular at the same depth as the root of the main screw thread portion or a depth deeper than the root may be used as the annular groove portion.

A loosening-stop bolt according to the second aspect of the invention is such that a loosening-stop bolt having a structure of a loosening-stop tightening means described in the first aspect, which is screwed in a female screw thread and tightens a member to be tightened, comprises: a bolt tip end portion formed coaxially with a bolt axis portion at the tip end portion of the above-described bolt axis portion; a main male screw thread portion formed on the outer circumference of the above-described bolt axis portion; a bolt-annular groove portion formed to be annular on the outer circumference at the bolt shank side of the bolt tip end portion; and a sub male screw thread portion, formed on the outer circumference of the above-described bolt tip end portion, whose phase with respect to the above-described main male screw thread portion is displaced by 12 through 100°, preferably 24 through 90° or further preferably 24 through 72°.

With such a construction, the following actions can be brought about.

(1) Since a loosening-stop bolt which is screwed in a female screw thread is such that the phase of the sub male screw thread portion with respect to the main male screw thread portion is displaced by a prescribed amount, the direction along which the flank of the main male screw thread portion is brought into contact with the flank of a female screw thread due to contact pressure generated by the tightening force differs by 180° from the direction along which the flank of the sub male screw thread portion is brought into contact with the flank of a female screw thread. That is, the directions run counter to each other. Therefore, the direction of a torque produced by the contact pressure and lead angle of the screw thread at the main male screw thread portion differs in terms of plus and minus from the direction thereof at the sub male screw thread portion, wherein if an external force such as vibrations is applied to a nut and a member to be tightened, and a force operating along the turning direction along which the main male screw thread portion is likely to be loosened from the female screw thread is added, a torque produced at the flank of the sub male screw thread portion operates in the tightening direction. Accordingly, it is possible to securely prevent the loosening-stop bolt from being loosened from the female screw threads, and a high tightening force can be semi-permanently maintained.

(2) Since a sub male screw thread portion is provided on the outer circumference of the tip end portion of the bolt, which is formed so that the phase thereof with respect to the main male screw thread portion is displaced by 12 through 100°, preferably 24 through 90° or further preferably 24 through 72°, a reaction force with which the sub male screw thread portion presses the female screw thread in the direction of the main male screw thread portion, and a reaction force with which the main male screw thread portion presses the female screw thread in the direction of the sub male screw thread portion, or a reaction force with which the sub male screw thread portion presses the female screw thread in the direction opposite to the main male screw thread portion, and a reaction force with which the main male screw thread portion presses the female screw thread in the direction opposite to the sub male screw thread portion are produced by screwing a loosening-stop bolt in the female screw thread when tightening a member to be tightened, whereby a large friction force can be obtained between the main male screw thread portion or the sub male screw thread portion and the female screw thread, and it is possible to securely prevent the screwing force from being lowered due to a loosening of the main male screw thread portion, etc., from the female screw thread due to vibrations.

(3) If a tightening force is added by screwing the loosening-stop bolt in a female screw thread, the sub male screw thread portion of the loosening-stop bolt is deformed by the female screw thread to cause resilient deformation, wherein the main male screw thread portion and sub male screw thread portion can be more firmly adhered and tightened to the female screw thread by the reaction force in resilient deformation. Herein, the screwing force of the loosening-stop bolt and female screw thread can be further increased, and it is possible to further securely prevent the loosening-stop bolt from being loosened from the female screw thread due to an external force such as vibrations.

(4) Even in a case where any loosening is produced by wearing between a member to be tightened and the bearing surface, it is possible to prevent the loosening-stop bolt from slipping off the female screw thread by a reaction force by which the sub male screw thread portion presses the female screw thread in the direction of the main male screw thread portion or a reaction force by which the sub screw thread portion presses the female screw thread in the direction opposite to the main male screw thread portion, wherein, if the loosening-stop bolt is applied to vehicles or bridges where vibrations are remarkable, it is possible to prevent a falling accident by which bolts and nuts slip out therefrom and drop.

(5) Since the main male screw thread portion and sub male screw thread portion are firmly adhered to the female screw thread by a reaction force resulting from resilient deformation which is produced by the sub male screw thread portion of the loosening-stop bolt screwed in the female screw thread being deformed by the female screw thread, play due to unevenness in machining accuracy of the female screw thread and the male screw thread portion of the loosening-stop bolt can be absorbed in resilient deformation, stability thereof is excellent, and at the same time, since the amount of displacement is small, the screw thread portions of the loosening-stop bolt and nut are hardly impaired when being tightened, wherein since the reaction force can be obtained in a stabilized state by resilient deformation, if the female screw thread is the same one, it can be re-screwed after the loosening-stop bolt is once removed and can be repeatedly used. That is, the bolt is excellent in repeated use.

(6) Since the loosening-stop bolt has a bolt-annular groove portion formed with the same depth as the root of the main male screw thread portion or deeper than the root diameter thereof, the main male screw thread portion can be smoothly screwed into the female screw thread when being screwed, and at the same time, deformation by compression or tension can be facilitated, wherein the degree of freedom in design can be increased, and it is possible to prevent the main male screw thread portion, etc., from being buckled in deformation by compression.

The bolt tip end portion is such that, at the tip end portion of the bolt shank, it is formed integrally with the bolt shank or fixed by welding at the bolt shank and formed coaxially with the bolt shank, and has an outer circumference formed with the same outer diameter as the one of the outer circumference of the bolt shank. The length of the bolt tip end portion is a length necessary to obtain suitable and secure engagement of the main male screw thread portion and sub male screw thread portion with the female screw thread in response to the material of the bolt tip end portion and material of the female screw thread to be screwed.

A bolt head, which is formed to be of a polygon such as a hexagonal member like a hexagon bolt, a column having a socket such as a hexagonal socket on the top face of a hexagonal socket head bolt, or a ring such as an eye bolt may be formed at the bolt shank at the opposite side of the bolt tip end portion. Also, a bolt having no bolt head like a stud bolt, a stay bolt, etc., in which a screw thread portion is formed, and a bolt that is formed to be L-shaped or J-shaped, etc., like an anchor bolt may be used.

The main male screw thread portion is formed to be like a triangular screw thread or trapezoidal screw thread such as metric screws and inch screws in response to a female screw thread, in which a loosening-stop bolt is screwed, on the outer circumference of the bolt shank at a pitch responsive to the female screw thread. A double-start through multiple-start screw thread may be formed in addition to a single-start screw thread. Also, the main male screw thread portion may be formed with a length, by which an engagement length necessary to be screwed with a female screw thread can be obtained, in response to a material of a bolt shank and bolt tip end portion and a material of the female screw thread in which the main male screw thread portion is screwed.

The bolt-annular groove portion is formed roughly orthogonal to or diagonally with the axial center of the bolt shank, and formed to be annular at the same depth as the root of the main male screw thread portion or deeper than the root thereof on the outer circumference of the bolt tip end portion. Then, the bolt-annular groove portion separates the main male screw thread portion and the sub male screw thread portion from each other. In particular, such a bolt-annular groove portion having the bolt tip end portion thereof formed to be thin, which is formed deeper than the root of the main male screw thread portion, is preferably employed. This is because resilient deformation is easy. If the bolt-annular groove portion is formed at the same depth as that of the root of the main male screw thread portion, it is considered that there is such a tendency by which thread ridges of the female screw thread and main male screw thread portion are easily crushed since it is difficult for elongation to occur in the large mechanical strength of the bolt tip end portion at the bolt-annular groove portion.

In addition, where the bolt-annular groove portion is formed to be diagonal with the axial center of the bolt shank, it is possible to form the same bolt-annular groove portion at an angle roughly parallel to the lead angle of the main male screw thread portion, whereby the female screw thread can be screwed, without any interlocking, at the sub male screw thread portion separated and formed by the main male screw thread portion and bolt-annular groove portion.

The sub male screw thread portion is spaced from the main male screw thread portion by the bolt-annular groove portion and is formed on the outer circumference of the bolt tip end portion with the same pitch as that of the main male screw thread portion and with the phase thereof with respect to the main male screw thread portion displaced by 12 through 100°, preferably 24 through 90° or further preferably 24 through 72°.

The amount of resilient deformation is decreased by play due to unevenness in machining accuracy of the female screw thread and male screw thread portion of the loosening-stop bolt in line with the phase of the sub male screw thread portion with respect to the main male screw thread portion becoming smaller than 24°, and such a tendency is brought about, by which the reaction force that the female screw thread obtains by the main male screw thread portion and sub male screw thread portion is decreased, and the screwing force of the loosening-stop bolt with the female screw thread is lowered. If the phase is 72 through 90°, the torque before tightening is large, and work efficiency is lowered. And such a tendency is brought about, by which seizing is liable to occur in use. If the phase exceeds 90°, the screw thread portion of the loosening-stop bolt is easily caught by or interlocked to the female screw thread when tightening, and a force necessary for tightening is increased, wherein tightening efficiency is worsened. Further, the screw thread portions of the loosening-stop bolt and nut are liable to be impaired, and the repeated use is also worsened. Therefore, a phase exceeding 90° is not preferable. In particular, where the phase with respect to the female screw thread, in which the female screw thread to be screwed in the sub male screw thread portion, is made smaller than 12° or exceeds 100°, the tendency is made remarkable, and neither of these is preferable.

Also, the phase of the sub male screw thread portion may be displaced in either side of the main male screw thread portion side or the opposite side of the main male screw thread portion. In either case, this is because the direction along which the flank of the main male screw thread portion presses the flank of the female screw thread due to contact pressure produced when being tightened can be made different by 180° from the direction along which the flank of the sub male screw thread portion presses the flank of the female screw thread.

The shape of the sub male screw thread portion and number of starts may be similar to those of the main male screw thread portion.

A female screw thread may be planted in the center part of a nut or a mechanical component or may be screwed in a prescribed part of a plate-shaped or ore-shaped structure.

The loosening-stop bolt according to the third aspect of the invention is such that, in addition to the loosening-stop bolt described in the second aspect, the bolt tip end portion is provided with a tip end recessed portion from the tip end of the bolt tip end portion to at least the bolt-annular groove portion centering around the axis center of the bolt tip end portion.

With such a construction, the following actions can be brought about in addition to those obtained by the second aspect.

(1) The shank of the bolt-annular groove portion is made thin by the tip end recessed portion, wherein the mechanical strength such as resilience and bending stress can be optimized, wherein a reaction force responsive to a screw thread portion can be obtained. Further, it is possible to prevent the screw thread portion from being damaged and for the same screw thread portion to be hardly loosened.

Herein, a tip end recessed portion may be used, which is formed from the tip end of the bolt tip end portion to a part of the bolt-annular groove portion or beyond the bolt-annular groove portion centering around the axial center of the bolt tip end portion in response to the degree of the bolt diameter or the degree of width of the bolt-annular groove portion. For example, where the bolt-annular groove portion is wide, the tip end recessed portion may reach the vicinity of the middle of the width of the bolt-annular groove portion. Also, where the bolt-annular groove portion is narrow, the tip end recessed portion is drilled in at least the entire width thereof. In particular, in the case where the tip end recessed portion is formed on the entire width of the bolt-annular groove portion, the tip end recessed portion may be used preferably because the shank of a thinned bolt-annular groove portion is formed to be long, and resilient deformation can be facilitated.

Also, a recessed portion having a large diameter, for which the inner diameter of the tip end recessed portion corresponding to the bolt-annular groove portion is enlarged, may be formed. By forming the recessed portion having a large diameter, it is possible to make the thickness of the bolt tip end portion thin to a prescribed thickness at the bolt-annular groove portion, wherein resilient deformation of the bolt tip end portion can be facilitated. In addition, the tip end recessed portion or recessed portion having a large diameter may be formed at a part of the bolt shank beyond the bolt-annular groove portion which is formed at the bolt tip end portion.

A loosening-stop bolt according to the fourth aspect of the invention is such that, in addition to the loosening-stop bolt described in the third aspect, the bolt tip end portion at the bolt-annular groove portion is provided with a bolt-resilient portion deformed by compression or tension in the axial direction.

With such a construction, the following actions can be brought about in addition to those obtained by the third aspect.

(1) Since the bolt tip end portion at the bolt-annular groove portion is provided with a bolt-resilient portion deformed by compression or tension, and the bolt-resilient portion has resiliency, the bolt-resilient portion can absorb play resulting from unevenness in machining accuracy of a female screw thread and a male screw thread portion of the loosening-stop bolt by elongation or contraction of the bolt-resilient portion, which is produced by the screwed female screw thread in addition to resilient deformation of the sub male screw thread portion, which is produced by the screwed female screw thread, and can further increase the reaction force, which is produced at the male screw thread portion by resiliency of the bolt-resilient portion, wherein it is possible to further reliably prevent the loosening-stop bolt from being loosened from the female screw thread.

(2) Since the bolt-annular groove portion can be deformed by compression and tension after the main male screw thread portion and sub male screw thread portion are formed with the same pitch and the same phase, it is possible to easily shift the phases of the main male screw thread portion and sub male screw thread portion, and production thereof can be facilitated, wherein productivity is excellent.

A loosening-stop bolt according to the fifth aspect of the invention is such that, in addition to the loosening-stop bolt described in the fourth aspect, where it is assumed that the size of a pitch of the main male screw thread portion is P, an α amount of deformation of the bolt-annular groove portion in the axial direction is (n+1/30)P≦α≦(n+5/18)P, preferably (n+1/15)P≦α≦(n+¼)P, further preferably (n+1/15)P≦α≦(n+⅕)P, or (n−5/18)P≦α≦(n−1/30)P, preferably (n−¼)P≦α≦(n−1/15)P,or further preferably (n−⅕)P≦α≦(n−1/15)P, (however, n is an integral number more than 0, and α is positive in the compressing direction and negative in the tensile direction).

With such a construction, the following actions can be brought about in addition to those obtained by the fourth aspect.

(1) By deforming the bolt-annular groove portion using the α amount of deformation, it is possible to securely displace the phase of the sub male screw thread portion with respect to the main male screw thread portion by 12 through 100°, preferably 24 through 90° or further preferably 24 through 72°, wherein product yields are high, and productivity thereof is excellent.

(2) Since the bolt-annular groove portion can be set to a prescribed amount of deformation by varying the figure“n”, and the resiliency of the bolt-resilient portion can be varied as long as the deformation of the bolt-annular groove portion is within the resiliency limit, the relationship between the displacement of the bolt-resilient portion and the reaction force thereof can be stabilized, and unevenness of the reaction force obtained is slight, wherein the stability is excellent.

A length (L2-L1) that is obtained by subtracting the length L1 of the bolt-annular groove portion in the axial direction after deformation from the length L2 of the bolt-annular groove portion in the axial direction before deformation is used as the α amount of deformation of the bolt-annular groove portion. It is preferable that, where it is assumed that the size of a pitch of the main male screw thread portion is P, an α amount of deformation of the bolt-annular groove portion is (n+1/30)P≦α≦(n+5/18)P, preferably (n+1/15)P≦α≦(n+¼)P, further preferably (n+1/15)P≦α≦(n+⅕)P, or (n−5/18)P≦α≦(n−1/15)P, preferably (n−¼)P≦α≦(n−1/15)P, or further preferably (n−⅕)P≦α≦(n−1/15)P, (however, n is an integral number more than 0, and α is positive in the compressing direction and negative in the tensile direction). If the amount of deformation of the bolt-annular groove portion becomes smaller than (n+1/15)P or larger than (n−1/15)P, it becomes difficult to absorb play resulting from unevenness in machining accuracy of the female screw thread of a nut, etc., and the male screw thread of a loosening-stop bolt, wherein the amount of resilient deformation is decreased, and a reaction force obtained at the female screw thread by the main male screw thread portion and sub male screw thread portion becomes slight. Then, such a tendency can be observed, by which the screwing force between the loosening-stop bolt and the female screw thread is lowered. If the amount of deformation becomes (n+⅕)P through (n+¼)P, the torque before tightening is increased to cause work efficiency to be lowered, and such a tendency can be observed, by which seizing is liable to occur in use. If the amount of deformation becomes larger than (n+¼)P or becomes smaller than (n−¼)P, the male screw thread portion of the loosening-stop bolt is easily interlocked to the female screw thread portion when tightening, a force necessary to tighten is increased, wherein the tightening efficiency is worsened, and the loosening-stop bolt and female screw thread are liable to be impaired when tightening. Then, such a tendency can be obtained, by which repeated use thereof may be made unsuitable. In particular, where the amount of deformation of the bolt-annular groove portion becomes smaller than (n+1/30)P or becomes larger than (n−1/30)P, or becomes larger than (n+5/18)P or becomes smaller than (n−5/18)P, the above-described tendencies become remarkable, and neither of these is preferable.

An integral number equal to or greater than 0 is used as “n”. A case where the α amount of deformation is α=(n+1/30)P is taken as an example for description. Since α=nP+1/30·P, no phase shift is produced by the amount of deformation nP where “n” is an integral number, and a phase shift may be formed by the amount of deformation 1/30·P, which is deformed beyond that. Further, 0 through 4 or 1 through 3 are preferably used as “n”. When “n” is 0, since the amount of deformation of the bolt-annular groove portion is made small, the resilience of the bolt-resilient portion is increased, wherein the degrees of reaction forces obtained by slight deformation of the bolt-resilient portion remarkably differ from each other, and the unevenness is made large, thereby causing the stability to be worsened. If the amount of deformation becomes larger than 3, the amount of deformation of the bolt-annular groove portion is large, wherein the resilience of the bolt-resilient portion is decreased, and the reaction force obtained by displacement of the bolt-resilient portion is made small. Neither of these is preferable. In particular, if“n” becomes larger than 4, the tendency becomes remarkable. An amount of deformation when“n” exceeds 4 is not preferable.

As the length L2 of the bolt-annular groove portion in the axial direction before deformation by compression, P≦L2≦5P+A−B where (a) the size of the pitch of the main male screw thread portion is P, the outer diameter of the bolt-annular groove portion is A, and the inner diameter of the tip end recessed portion is B, or L2=L1/cos θ1 (however, 10°≦θ1 ≦75°) where (b) the length of the bolt-annular groove portion in the axial direction after deformation by compression is L1, and the angle of deformation of the bolt-resilient portion with respect to the axial direction is θ1, are preferably used.

Thereby, the following actions can be brought about.

(1) Since the length of the bolt-annular groove portion in the axial direction before deformation by compression is within a prescribed range, the buckling load of the bolt-annular groove portion is made adequate, and the bolt-annular groove portion is deformed by compression, wherein the phase of the sub male screw thread portion can be easily displaced to a prescribed range. Herein, excellent productivity and stability thereof can be secured.

(2) Since the length of the bolt-annular groove portion in the axial direction before deformation by compression is within a prescribed range, the bolt-resilient portion can be accommodated in the bolt-annular groove portion where deformation is carried out by compression, and the bolt-resilient portion formed has an excellent degree of freedom in size, etc.

(3) Where the angle θ1 of deformation of the bolt-resilient portion is formed in a prescribed range, optimal resiliency of the bolt-resilient portion can be obtained, and at the same time, stable relationship between displacement and reaction forces of the bolt-resilient portion can be obtained, wherein unevenness in the reaction forces obtained is made slight, and excellent stability can be secured.

Herein, where the size of the pitch of the main male screw thread portion is P, the outer diameter of the bolt-annular groove portion is A, and the inner diameter of the tip end recessed portion is B, P≦L2≦5P+A−B is preferably used as the length L2 of the bolt-annular groove portion in the axial direction before deformation by compression. As the length of the bolt-annular groove portion in the axial direction before deformation by compression is made smaller than the size P of one pitch of the main male screw thread portion, the mechanical strength of the bolt tip end portion at the bolt-annular groove portion is increased and compresses and deforms the bolt-annular groove portion, wherein a large load is required and results in an increase in the facility load such as a press machine facility, and the sub male screw thread portion except for the bolt-annular groove portion is easily subjected to deformation, resulting in a decrease in the pitch of the sub male screw thread portion, wherein the sub male screw thread portion is easily interlocked to a female screw thread such as a nut, etc. Further, the α amount of deformation cannot be increased, and it becomes difficult to increase the stability. If the length L2 is made larger than 5P+A−B, the buckling load is decreased, and the stability is lowered, wherein an axial slip of the main male screw thread portion and sub male screw thread portion is liable to occur, wherein it becomes difficult for the sub male screw thread portion and the main male screw thread portion to be screwed in the female screw thread, and the mechanical strength of the sub male screw thread portion is decreased. That is, the sub male screw thread portion may be subjected to fatigue, resulting in a lowering in long-term reliability.

Also, L2=L1/cos θ1 (however, 10°≦θ1≦75°) is preferably used as the length L2 of the bolt-annular groove portion in the axial direction before deformation by compression where the length of the bolt-annular groove portion in the axial direction after deformation by compression is L1, the angle of deformation of the bolt-resilient portion with respect to the axial direction is θ1. If the angle θ1 of deformation of the bolt-resilient portion with respect to the axial direction is made smaller than 10°, the resiliency of the bolt-resilient portion is increased since the amount of deformation of the bolt-annular groove portion is small, and the sizes of reaction forces obtained by slight displacement of the bolt-resilient portion remarkably differ from each other, wherein unevenness is made large, and the stability is worsened. And, if the angle θ1 of deformation becomes larger than 75°, the amount of deformation of the bolt-annular groove portion is large, and the resiliency of the bolt-resilient portion is decreased, wherein reaction forces obtained by displacement of the bolt-resilient portion is decreased. Neither case is preferable.

A loosening-stop bolt according to the sixth aspect of the invention is such that, in addition to the loosening-stop bolt described in any one of the second aspect through the fifth aspect, the cross sectional area of the shank of the bolt-annular groove portion is 5 through 50% of the cross sectional area at the root of the bolt shank.

With such a construction, the following actions can be brought about in addition to those obtained by the second aspect through the fifth aspect.

(1) Since the reaction force Q that the sub male screw thread portion gives to the female screw thread can be set in a prescribed range by regulating the cross sectional area of the shank of the bolt-annular groove portion, it is possible to suppress a free torque Tq before tightening, which is expressed by Equation (1), to 1 through 50N·m or so, wherein the tightening efficiency is excellent.

[Equation 1]

(2) Since the thickness of the shank of the bolt-annular groove portion is formed to be a prescribed thickness and the mechanical strength is set to a prescribed range, the phase of the sub male screw thread portion can be easily displaced in a prescribed range by deforming the bolt tip end portion. Also, an adequate length of elongation is liable to be produced at the shank of the bolt-annular groove portion, wherein the shank is elongated when being screwed in the female screw thread, and thread ridges of the female screw thread and sub male screw thread portion are hardly impaired. Excellent mounting can be secured.

Herein, the cross sectional area of the shank of the bolt-annular groove portion is an area surrounded by the outer edge (outer diameter) of the bolt-annular groove portion where no tip end recessed portion is provided or an area obtained by subtracting an area surrounded by the inner edge (inner diameter) of the tip end recessed portion from an area surrounded by the outer edge (outer diameter) of the bolt-annular groove portion where the tip end recessed portion is provided. It is preferable that the cross sectional area is 5 through 50% of the cross sectional area on the root of the bolt shank. As the cross sectional area is made smaller than 5%, the buckling load is also decreased, and the mechanical strength is lowered. If the cross sectional area exceeds 50%, the buckling load of the shank is increased, and elongation or contraction is hardly produced, wherein the free torque is increased, and the flank may be impaired, or seizing is liable to occur. Therefore, it is not preferable that the cross sectional area is smaller than 5% or larger than 50%.

Also, when a tip end recessed portion is formed, the thickness (the thickness from the root of the sub male screw thread portion to the inner circumferential wall of the tip end recessed portion) at the sub male screw thread portion of the bolt tip end portion is a thickness by which a mechanical strength necessary for being screwed in the female screw thread can be obtained in response to the material of the bolt tip end portion.

A method for producing a loosening-stop bolt having the structure of the loosening-stop tightening means described in the first aspect, according to the seventh aspect of the invention, which is screwed in a female screw thread and tightens a member to be tightened; comprises the steps of: forming a tip end recessed portion by drilling the bolt shank at its center from the tip end thereof; forming a bolt-annular groove portion at the same depth as that of a root of a male screw thread or deeper than the depth of the root on the outer circumference of a prescribed part at the tip end side of the bolt shank; applying prescribed load roughly in parallel to the bolt shank for a prescribed period of time, and forming a bolt-resilient portion by deforming the bolt shank at the bolt-annular groove portion formed by the step of forming the bolt-annular groove portion so that, where it is assumed that the size of a pitch of the male screw thread is P, the α amount of deformation becomes (n+1/30)P≦α≦(n+5/18)P, preferably (n+1/15)P≦α≦(n+1/15)P, further preferably (n+1/15)P≦α≦(n+⅕)P, or (n−5/18)P≦α≦(n−1/30)P, preferably (n−¼)P≦α≦(n−1/15)P, or further preferably (n−⅕)P≦α≦(n−1/15)P, (however, n is an integral number more than 0, and α is positive in the compressing direction and negative in the tensile direction).

With such a construction, the following actions can be brought about.

(1) By deforming the bolt shank at the bolt-annular groove portion on which the tip end recessed portion is formed, the main male screw thread portion and sub male screw thread portion whose phase shifts can be easily formed. Therefore, production thereof is easy and productivity thereof is excellent.

(2) Since the bolt shank at the bolt-annular groove portion is deformed by the α amount of deformation, the phase of the sub male screw thread portion with respect to the main male screw thread portion may be securely displaced by 12 through 100°, preferably 24 through 90° or further preferably 24 through 72°, reliability thereof and work efficiency thereof are excellent.

Herein, the steps of forming the bolt-annular groove portion and tip end recessed portion form the bolt-annular groove portion and tip end recessed portion on the outer circumference of the bolt shank, on which a male screw thread is formed, and at the tip end side of the bolt shank, by cutting using a lathe or a milling machine.

If the tip end recessed portion is drilled and formed from the tip end of the axis center of the bolt shank to at least the bolt-annular groove portion, the step of forming a tip end recessed portion may be carried out next to the step of forming a bolt-annular groove portion, and the step of forming a bolt-annular groove portion may be carried out next to the step of forming a tip end recessed portion.

Applying a prescribed load roughly in parallel to the bolt shank for a prescribed period of time using a pressing device may form the bolt-resilient portion. It is preferable that the load is applied in a cold state, wherein the mechanical strength can be increased, and high dimensional accuracy can be obtained.

A loosening-stop nut according to the eighth aspect of the invention is a nut having a structure of a loosening-stop tightening means described in the first aspect, which is screwed in a male screw thread of a bolt and tightens a member to be tightened. The loosening-stop nut comprises: a nut body, an extending portion extending coaxially with the nut body; a main female screw thread portion formed on the inner circumferential wall of the nut body; a nut-annular groove portion formed to be equal to the root diameter of the main female screw thread portion or to be larger than the root diameter thereof on the inner circumferential wall at the nut body side of the extending portion or on the inner circumferential wall of the nut body; and a sub female screw thread portion, formed on the inner circumferential wall of the extending portion, whose phase with respect to the main female screw thread portion is displaced by 12 through 100°, preferably 24 through 90° or further preferably 24 through 72°.

With such a construction, the following actions can be brought about.

(1) Since the phase of the sub female screw thread portion with respect to the main female screw thread portion is displaced by a prescribed amount in the loosening-stop nut tightened by a male screw thread, the direction along which the flank of the main female screw thread portion is brought into contact with the flank of a male screw thread due to contact pressure produced by the tightening force differs by 180° from the direction along which the flank of the sub female screw thread portion is brought into contact with the flank of a male screw thread. That is, the directions run counter to each other. Therefore, the direction of a torque produced by the contact pressure and lead angle of the screw thread at the main female screw thread portion differ in terms of plus and minus from the direction of a torque thereof at the sub female screw thread portion, wherein, if an external force such as vibrations is applied to a bolt and a member to be tightened, and a force operating along the turning direction along which the main female screw thread portion is likely to be loosened from the male screw thread is added, a torque produced at the flank of the sub female screw thread portion operates in the tightening direction. Accordingly, it is possible to securely prevent the loosening-stop nut from being loosened from the male screw threads, and a high tightening force can be semi-permanently maintained.

(2) A sub female screw thread portion formed so that the phase thereof with respect to the main female screw thread portion is displaced by 12 through 100°, preferably 24 through 90° or further preferably 24 through 72° is provided on the inner circumferential wall of an extension portion extending on the nut body. Therefore, a reaction force with which the sub female screw thread portion presses the male screw thread in the direction of the main female screw thread portion, and a reaction force with which the main male screw thread portion presses the male screw thread in the direction of the sub female screw thread portion, or a reaction force with which the sub female screw thread portion presses the male screw thread in the direction opposite to the main female screw thread portion, and a reaction force with which the main female screw thread portion presses the male screw thread in the direction opposite to the sub female screw thread portion are produced by screwing a loosening-stop nut in the male screw thread of a bolt when tightening a member to be tightened, whereby a large friction force can be obtained between the main female screw thread portion or the sub female screw thread portion and the male screw thread, it is possible to securely prevent the screwing force from being lowered due to a loosening of the main female screw thread portion, etc., from the male screw thread due to vibrations.

(3) Where a loosening-stop nut is tightened to a male screw thread of a bolt, and a tightening force is applied thereto, the sub female screw thread portion of the loosening-stop nut is resiliently deformed by a male screw thread of a bolt, and this can be tightened so that the main female screw thread portion and sub female screw thread portion are further tightly adhered to the male screw thread by the reaction force within the resilient deformation. Therefore, the screwing force of the loosening-stop nut with a male screw thread of a bolt is increased, and it is possible to further securely prevent the loosening-stop nut from being loosened from the male screw thread of a bolt by an external force such as vibrations.

(4) Even where wearing occurs between a member to be tightened and the bearing surface, and looseness is produced, the loosening-stop nut can be prevented from slipping off a bolt, etc., by a reaction force by which the sub female screw thread portion presses the male screw thread in the direction of the main female screw thread portion or a reaction force by which the sub female screw thread portion presses the male screw thread in the direction opposed to the main female screw thread portion, wherein it is possible to prevent the loosening-stop nut from falling down from a bolt or the like, and it is possible to prevent a nut, a bolt or the like from falling from vehicles and bridges where vibrations of vehicles and tramcars are remarkable.

(5) Since the main female screw thread portion and sub female screw thread portion are tightly adhered to a male screw thread by a reaction force resulting from resilient deformation produced by the sub female screw thread portion of a loosening-stop nut, which is screwed with a male screw thread of a bolt, being deformed by the male screw thread, it is possible to absorb play due to unevenness in machining accuracy of a male screw thread of a bolt and a female screw thread portion of a loosening-stop nut, wherein excellent stability can be secured. Also, since the amount of displacement in the phase is slight, the loosening-stop nut and screw thread portion of a bolt are scarcely impaired when tightening, wherein a stable reaction force can be obtained. Therefore, if the male screw thread is the same one, it can be re-screwed after the loosening-stop nut is once removed and can be repeatedly used. That is, the bolt is excellent in repeated use.

(6) Since the loosening-stop nut has a nut-annular groove portion formed with the same diameter as the root diameter of the main female screw thread portion or with a larger outer diameter than the root diameter, the sub female screw thread portion can be smoothly screwed with a male screw thread of a bolt, and the deformation can be facilitated, wherein the degree of freedom in design can be secured, and buckling can be prevented from occurring.

Herein, a nut body may be a polygonal nut which is square pillar-shaped and hexagonal pillar-shaped, or a round nut, or various types of nuts, for example, a nut with a flange. The bearing surface of the nut body may be adhered to or fixed at a member to be tightened.

The extending portion is such that it is formed integrally with a nut body on the top face portion of the nut body or prepared separately therefrom, and is fixed on the top face portion of the nut body by welding, is caused to extend coaxially with the nut body, is formed so that the outer profile is roughly circular or roughly polygonal, and has an inner circumferential wall formed to be flush with the inner circumferential wall of the nut body. Further, the extending portion is formed so as to have a length by which an engagement length necessary to be screwed with the male screw thread can be obtained, in response to the material of the extending portion or a material of the male screw thread to be screwed.

The main female screw thread portion is formed in the form of a triangular screw thread or trapezoidal screw thread such as metric screws and inch screws in response to a male screw thread, in which a loosening-stop nut is screwed, on the inner circumferential wall of the nut body at a pitch responsive to the male screw thread. It is possible to form a main female screw thread portion having a prescribed length on the inner circumferential wall of the extending portion in continuity with the main female screw thread portion formed on the inner circumferential wall of the nut body. Also, the main female screw thread portion is formed with a length by which an engagement length necessary to be screwed with the male screw thread can be obtained in response to the material of the nut body and the extending portion, and a material of the male screw thread with which the main female screw thread portion is screwed. A double-start to multiple-start screw thread may be formed in addition to a single-start screw thread as types of screw threads.

The nut-annular groove portion is formed roughly orthogonal to or diagonally with the axial center of the nut body, and the nut-annular groove portion separates the main female screw thread portion and sub female screw thread portion, which are formed with the same diameter of the root diameter of the main female screw thread portion or with a larger diameter than the root diameter thereof on the inner circumferential wall of the extending portion at the nut body side or on the inner circumferential wall of the nut body, and simultaneously makes the extending portion and nut body thin.

Also, where the nut-annular groove portion is formed diagonally with the axial center of the nut body, it is possible to form the nut-annular groove portion roughly in parallel to the lead angle of the main female screw thread portion, whereby the male screw thread can be screwed in the main female screw thread portion or the sub female screw thread portion separated therefrom by the nut-annular groove portion without being interlocked thereto.

The sub female screw thread portion is spaced from the main female screw thread portion by the nut-annular groove portion and is formed on the inner circumferential wall of the extending portion with the same pitch as that of the main female screw thread portion and with the phase thereof with respect to the main female screw thread portion displaced by 12 through 100°, preferably 24 through 90° or further preferably 24 through 72°.

Where the phase of the sub female screw thread portion with respect to the main female screw thread portion becomes smaller than 24°, the resilient deformation amount is decreased by play due to unevenness in machining accuracy of a male screw thread of a bolt and a female screw thread portion of a loosening-stop nut, wherein a reaction force is obtained at the male screw thread by the main female screw thread portion and sub female screw thread portion, and there is a tendency by which the screwing force of the loosening-stop nut with the male screw thread of a bolt is lowered. If the phase becomes 72 through 90°, a torque in tightening is increased, wherein seizing is liable to occur. Therefore, this is not preferable. If the phase becomes larger than 90°, when tightening, the screw thread portion of a loosening-stop nut is easily interlocked to the screw thread portion of a bolt, and the force necessary to tighten is increased, wherein tightening work efficiency is worsened, and the screw thread portions of the loosening-stop nut and bolt are easily impaired when being tightened. There is a tendency by which repeated use thereof is worsened. This is not preferable. In particular, if the phase of the sub female screw thread portion with respect to the main female screw thread portion becomes smaller than 12° or larger than 100°, these tendencies are made remarkable. Neither of these is preferable.

In addition, the phase of the sub female screw thread portion may be displayed to the main female screw thread portion side or to the side opposite to the main female screw thread portion. In either case, this is because the direction along which the flank of the main female screw thread portion is brought into contact with the flank of a male screw thread due to contact pressure produced by the tightening force can be made different by 180° from the direction along which the flank of the sub female screw thread portion is brought into contact with the flank of a male screw thread.

The profile and number of starts of the sub female screw thread portion are similar to those of the main female screw thread portion.

A bolt having a polygonal head or a disk-shaped head such as a hexagonal bolt, a square neck bolt, etc., a bolt having a socket on the top face of the head such as a hexagonal socket headed bolt, a bolt, one end of which is buried, such as an anchor bolt, having a male screw thread formed on one end thereof, or a bolt having a male screw thread formed on both ends thereof such as an embedded bolt, or a stay bolt may be used as the bolt.

Also, a nut-annular groove portion is formed on a prescribed part of the inner circumferential wall of the nut having a female screw thread formed on its inner-circumferential wall, and a part of the nut from the bearing surface of a nut to the nut-annular groove portion may be made into a nut body while a part of a nut from the nut-annular groove portion to the top face of the nut is made into an extending portion. Thereby, it is possible to form a sub female screw thread portion (a female screw thread formed on the extending portion) whose phase with respect to the female screw thread (main female screw thread portion) formed on the nut body is displaced by 12 through 100° by only applying a load roughly in parallel to the axial direction, and it is possible to easily and simply produce a loosening-stop nut.

A loosening-stop nut according to the ninth aspect of the invention is a nut having a structure of a loosening-stop tightening means described in the first aspect, which is screwed in a male screw thread of a bolt and tightens a member to be tightened, wherein the nut comprises: a nut body, an extending portion extending coaxially with the nut body; a main female screw thread portion formed on the inner circumferential wall of the nut body; an outer circumferential groove portion formed in a direction orthogonal with the axial direction of the nut body on the outer circumferential wall at the nut body side of the extending portion or on the outer circumferential wall of the nut body; and a sub female screw thread portion, formed on the inner circumferential wall of the extending portion, whose phase with respect to the main female screw thread portion is displaced by 12 through 100°, preferably 24 through 90° or further preferably 24 through 72°.

With such a construction, the following actions can be brought about in addition to those described in the eighth aspect of the invention.

(1) If an outer circumferential groove portion is formed on the outer circumferential wall of a nut body formed of a nut which is standardized by JIS, ASME, DIN, etc., it is possible to form a sub female screw thread portion whose phase with respect to the main female screw thread portion is displaced by 12 through 100° by only applying a load roughly in parallel to the axial direction, wherein excellent universal use can be obtained.

Herein, since the nut body, extending portion, main female screw thread portion and sub female screw thread portion are described in the eighth aspect of the invention, a description thereof is omitted.

The outer circumferential groove portion is formed at a width of 1/30 times or more, preferably at a width of 1/30 through 5/18×n times (however, “n” is a natural number), the pitch of the main female screw thread portion or sub female screw thread portion. This is because the phase of the sub female thread portion with respect to the main female screw thread portion may be displaced by 12 through 100° when the outer circumferential groove portion is deformed by compression.

Also, an outer-circumferential groove portion is formed at a prescribed portion of the outer-circumferential wall of a nut having a female screw thread formed on its inner-circumferential wall, wherein a part of the nut from the bearing surface of the nut to the outer-circumferential groove portion may be made into a nut body, and a part of the nut from the outer-circumferential groove portion to the top face of the nut may be made into an extending portion.

A loosening-stop nut according to the tenth aspect of the invention is a nut defined in the eighth aspect of the invention, which further comprises an outer circumferential groove portion formed on the extending portion or on the outer circumferential wall of the nut-annular groove portion of the nut body.

With such a construction, the following actions can be brought about in addition to those obtained by the eighth aspect of the invention.

(1) Since elongation and deformation can be facilitated by making thin the extending portion at the nut-annular groove portion or the nut body, wherein the flanks of the main female screw thread portion and sub female screw thread portion press the flank of the male screw thread without impairing the male screw thread of a bolt, etc., and the thread ridges of the sub female screw thread portion, a screwing force can be obtained. Since the mechanical strength is sufficiently large to cause the elongation and contraction to hardly occur if the extending portion at the nut-annular groove portion or the nut body are made thick, the male screw thread of a bolt, etc., and thread ridges of the sub female screw thread portion may be damaged.

Herein, since the outer circumferential groove portion is similar to that described in the ninth aspect of the invention, a description thereof is omitted.

A loosening-stop nut according to the eleventh aspect of the invention is a nut as set forth in any one of the eighth aspect to the tenth aspect of the invention, wherein the nut-annular groove portion, extending portion at the outer circumferential groove portion or nut body is provided with a nut-resilient portion deformed by compression or tension in the axial direction.

With such a construction, the following actions can be provided in addition to those described in any one of the eighth aspect to the tenth aspect of the invention.

(1) Since the nut-resilient portion in which the extending portion at the nut-annular groove portion being deformed by compression or tension has resiliency, play due to unevenness in machining accuracy of the male screw thread and female screw thread portion of the loosening-stop nut can be absorbed by elongation or contraction of the nut-resilient portion, which is brought about by a male screw thread of a bolt screwed, in addition to resilient deformation of the sub female screw thread portion, which is produced by the male screw thread of the bolt screwed, and at the same time, a reaction force that is produced can be further increased by stress generated in response to the resiliency which the nut-resilient portion has, wherein it is possible to further securely prevent the loosening-stop nut from being loosened from the male screw thread of a bolt, etc.

(2) Since the nut-annular groove portion is deformed by compression or tension after the main female screw thread portion and sub female screw thread portion are formed with the same pitch and phase, it is possible to easily shift the phase of the main female screw thread portion and sub female screw thread portion. Therefore, production thereof is easy, and excellent productivity can be brought about.

Herein, it is preferable that the nut-resilient portion is formed so as to swell outward, since it is easy to produce. Also, the nut-resilient portion may be formed so as to swell in the nut-annular groove portion by restricting the outer circumferential side of the nut-resilient portion when forming the same. In this case, the nut-resilient portion is not swelled beyond the roots of the main female screw thread portion and sub female screw thread portion. Otherwise, the male screw thread is not inserted.

The loosening-stop nut according to the twelfth aspect of the invention is a loosening-stop nut according to the tenth or eleventh aspect of the invention, wherein, where it is assumed that the size of a pitch of the main female screw thread portion is P′, a γ amount of deformation of the nut-annular groove portion or the outer circumferential groove portion in the axial direction is (n+1/30)P′≦γ≦(n+5/18)P′, preferably (n+1/15)P′≦γ≦(n+¼)P′, further preferably (n+1/15)P′≦γ≦(n+⅕)P′, or (n−5/18)P′≦γ≦(n−1/30)P′, preferably (n−¼)P′≦γ≦(n−1/15)P′, or further preferably (n−⅕)P′≦γ≦(n−1/15)P′, (however, n is an integral number more than 0, and γ is positive in the compressing direction and negative in the tensile direction).

With such a construction, the following actions can be brought about in addition to those described in the tenth or eleventh aspect of the invention.

(1) Since, by deforming the nut-annular groove portion, etc., by the γ amount of deformation, the phase of the sub female screw thread portion with respect to the main female screw thread portion can be displaced without fail by 12 through 100°, preferably 24 through 90° or further preferably 24 through 72°, production yield thereof is high, and productivity thereof is high.

Herein, the γ amount of deformation of the nut-annular groove portion or the outer circumferential groove portion is a length (=L4−L3) obtained by subtracting a length L3 of the nut-annular groove portion or the outer circumferential groove portion in the axial direction after deformation from a length L4 of the nut-annular groove portion in the axial direction before deformation. Where the size of a pitch of the main female screw thread portion is P′, the amount of deformation may be (n+1/30)P′≦γ≦(n+5/18)P′, preferably (n+1/15)P′≦γ≦(n+¼)P′, further preferably (n+1/15)P′≦γ≦(n+⅕)P′, or (n−5/18)P′≦γ≦(n−1/30)P′, preferably (n−¼)P′≦γ≦(n−1/15)P′, or further preferably (n−⅕)P′≦γ≦(n−1/15)P′, (however, n is an integral number more than 0, and γ is positive in the compressing direction and negative in the tensile direction). If the γ amount of deformation of the nut-annular groove portion becomes smaller than (n+1/15)P′ or becomes larger than (n−1/15)P′, it is difficult for play due to unevenness in machining accuracy of the male screw thread of a bolt, etc., and the female screw thread portion of the loosening-stop nut to be absorbed, wherein the resilient amount of deformation is decreased, and a reaction force obtained at the male screw thread by the main female screw thread portion and sub female screw thread portion is reduced, wherein the screwing force of the loosening-stop nut and the male screw thread of a bolt, etc., is lowered. When the amount of deformation becomes (n+1/15)P′≦γ≦(n+¼)P′, a torque is made large when tightening, and seizing thereof may be liable to occur. If the γ amount of deformation becomes larger (n+¼)P′, or becomes smaller than (n−¼)P′, the screw thread portion of the loosening-stop nut is easily interlocked to the screw thread portion of a bolt when tightening, and a force necessary to tighten is increased, wherein tightening efficiency is worsened, and the loosening-stop nut and screw thread portion of the bolt are apt to be impaired, wherein repeated use thereof is worsened. This is not preferable. In particular, if the γ amount of deformation of the nut-annular groove portion, etc., becomes smaller (n+1/30)P′ or becomes larger than (n−1/30)P′, or the γ amount of deformation of the nut-annular groove portion, etc., becomes larger than (n+5/18)P′ or becomes smaller than (n−5/18)P′, neither is preferable because all of these are remarkable.

An integral number equal to or greater than 0 may be used as “n”. A case where they amount of deformation is γ =(n+1/30)P′ is taken as an example, where γ=nP′+1/30·P′ and n is any integral number, no phase shift occurs due to the amount of deformation nP′, and a slip in phase can be formed by the amount of deformation 1/30·P′, which is formed beyond the same. Further, the integral number may be 0 through 4 or 1 through 3 may be used still more preferably. When “n” is 0, the resiliency of the nut-resilient portion is increased since the amount of deformation of the nut-annular groove portion, etc., is small, and the size of the reaction force obtained by slight displacement of the nut-resilient portion remarkably differs, wherein the unevenness is large and stability is worsened. If“n” becomes larger than 3, the amount of deformation of the nut-annular groove portion, etc., is increased, and the resiliency of the nut-resilient portion is decreased, wherein there is a tendency, by which the reaction force obtained by displacement of the nut-resilient portion is made small. Therefore, neither is preferable. In particular, the tendency becomes excessive if “n” becomes larger than 4. This is not preferable.

The length L4 of the nut-annular groove portion or outer circumferential groove portion in the axial direction before deformation by compression is P′≦L4≦5P′+D−C where (a) it is assumed that the size of the pitch of the main female screw thread portion is P′, the inner diameter of the nut-annular groove portion is C, the outer diameter of the extending portion at the nut-annular groove portion or nut body, or the outer diameter of the outer circumferential groove portion is D, or L4=L3/cos θ2 may be used preferably (however, 10°≦θ2≦75°) where (b) the length of the nut-annular groove portion or the outer circumferential groove portion in the axial direction after deformation by compression is L3, the angle of deformation with respect to the axial direction of the nut-resilient portion is θ2. These are preferably used.

With such a construction, the following actions can be brought about.

(1) Since the length of the nut-annular groove portion in the axial direction is within a prescribed range, it is possible to easily displace the phase of the sub female screw thread portion with in a prescribed range by making adequate the buckling load of the nut-annular groove portion, etc., and deforming by compression, wherein excellent production can be secured, and excellent stability can be also secured.

(2) Since the length of the nut-annular groove portion in the axial direction before deformation by compression is within a prescribed range, it is possible to increase the degree of freedom in design when determining the size of the amount of deformation by compression and the size of the nut-resilient portion.

(3) If the angle θ2 of deformation of the nut-resilient portion is formed within a prescribed range, optimal resiliency of the nut-resilient portion can be secured, and simultaneously a stable relationship between the displacement and reaction force of the nut-resilient portion can be obtained, wherein unevenness in the reaction force obtained is slight, and excellent stability can be secured.

Herein, P′≦L4≦5P′+D−C is preferably used as the length L4 of the nut-annular groove portion in the axial direction before deformation by compression. If the length L4 of the nut-annular groove portion in the axial direction before deformation by compression becomes smaller than P′, the mechanical strength of the extending portion at the nut-annular groove portion is large, and the nut-annular groove portion is deformed by compression, wherein a large load is required resulting in an increase in the facility load such as a press machine facility, and at the same time, the sub female screw thread portion other than the nut-annular groove portion is liable to be deformed. The pitch of the sub female screw thread portion is decreased, a male screw thread of a bolt is easily interlocked to the sub female screw thread portion, wherein the γ amount of deformation cannot be increased to cause the stability to be hardly increased. If the length L4 is increased beyond 5P′+D−C, the buckling load is decreased to cause the stability to be lowered, wherein axial slip is likely to occur between the main female screw thread portion and sub female screw thread portion. It becomes difficult for a bolt and the like to be screwed in the sub female screw thread portion, and since the mechanical strength of the sub female screw thread portion is not sufficient, long-term reliability may be lowered.

Also, where the length of the nut-annular groove portion in the axial direction after deformation by compression is L3, the angle of deformation of the nut-resilient portion in the axial direction is θ2, L4=L3/cos θ2 (however, 10°θ2≦75°) is preferably used as the length L4 of the nut-annular groove portion or the outer circumferential groove portion in the axial direction before deformation by compression. If the angle θ of deformation of the nut-resilient portion in the axial direction becomes smaller than 10°, the resiliency of the nut-resilient portion is increased while the amount of deformation of the nut-annular groove portion is small, the magnitudes of reaction forces obtained by slight displacement of the nut-resilient portion remarkably differ, and are remarkably uneven. Therefore, stability is worsened. If the angle θ of deformation of the nut-resilient portion in the axial direction becomes larger than 75°, the resiliency of the nut-resilient portion is made small while the amount of deformation of the nut-annular groove portion is increased, wherein the reaction force secured by displacement of the nut-resilient portion is made small. Neither of these is preferable.

A loosening-stop nut according to the thirteenth aspect of the invention is a loosening-stop nut according to any one of the eighth aspect through the twelfth aspect of the invention, wherein the cross sectional area of the nut-annular groove portion, the extending portion of the outer circumferential groove portion or the nut body is 5 through 50% of the area of a circle whose diameter is the root diameter of the above-described main female screw thread portion.

With such a construction, the following actions can be provided in addition to those obtained in any one of the eighth aspect through the twelfth aspect of the invention.

(1) Since the reaction force Q which the sub female screw thread portion gives to the male screw thread can be set to a prescribed range by regulating the cross sectional area of the extending portion at the nut-annular groove portion, it is possible to suppress a free torque Tq before tightening, which is expressed by Equation 2 to approx. 1 through 50N. m and the like, wherein the tightening efficiency is excellent.

[Equation 2]

(2) Since the mechanical strength is secured within a prescribed range by forming the thickness of the extending portion at the nut-annular groove portion to a prescribed thickness, it is possible to displace the phase of the sub female screw thread portion within a prescribed range by deforming the extending portion. Also, adequate elongation is apt to occur at the extending portion at the nut-annular groove portion, wherein the extending portion, etc., is adequately elongated when a male screw thread of a bolt is screwed, and the screw thread ridges of the male screw thread and sub female screw thread portion are scarcely impaired. Therefore, excellent mountability can be secured.

Herein, the cross sectional area of the extending portion at the nut-annular groove portion or the outer circumferential groove portion or the nut body is used as an area obtained by subtracting an area surrounded by the inner edge (inner diameter) of the nut-annular groove portion from an area surrounded by the outer edge (outer diameter) of the outer circumferential wall of the extending portion at the nut-annular groove portion or the nut body and an area surrounded by the outer edge (outer diameter of the outer circumferential groove portion) of the extending portion at the outer circumferential groove portion, and the cross sectional area thereof is a cross sectional area which is 5 through 50% of the area of a circle whose diameter is the root diameter of the main female screw thread portion. If the cross sectional area becomes smaller than 5%, the buckling load becomes small, and simultaneously the mechanical strength is also lowered. If the area exceeds 50%, the buckling load of the extending portion at the nut-annular groove portion is increased, and simultaneously, elongation scarcely occurs. Since a free torque Tq is increased, the flanks may be impaired or seizing is apt to occur. Thus, it is not preferable that the area exceeds 50%.

Further, the thickness (the thickness from the root of the sub female screw thread portion to the outer circumferential wall of the extending portion) at the sub female screw thread portion of the extending portion may be formed so as to obtain a mechanical strength necessary to be screwed with a male screw thread in response to a material of the extending portion.

A loosening-stop nut according to the fourteenth aspect of the invention is a nut according to any one of the eighth aspect through the thirteenth aspect of the invention, wherein the extending portion is provided with a collar portion protruding to the peripheral portion of the outer circumferential wall.

With such a construction, the following actions can be brought about in addition to those described in any one of the eighth aspect through the thirteenth aspect of the invention.

(1) Since the nut-resilient portion swelled out by a compression deformation is accommodated between the collar portion protruded to the outer circumferential wall of the extending portion and the inside of the nut body, it is possible to prevent a wrench, which is used to tighten a loosening-stop nut, from being brought into contact with the nut-resilient portion, and to prevent the nut-resilient portion from being deformed or impaired, wherein the nut-resilient portion can be protected to increase durability.

Herein, a collar portion whose outer edge profile is roughly circular or a polygon of a roughly hexagonal shape may be used.

The size of the collar portion is formed so as to have the same diameter as the outer diameter of the nut-resilient portion having the outer edge of the collar portion swelled, or larger than the outer diameter thereof. The nut-resilient portion is accommodated in the collar portion and inside the nut body, and simultaneously for preventing the wrench, etc., from being brought into contact with the collar portion when tightening the nut body, wherein tightening efficiency can be improved.

A loosening-stop nut according to the fifteenth aspect of the invention is a loosening-stop nut described in any one of the eighth aspect through the fourteenth aspect of the invention, wherein the outer diameter of the extending portion is formed to be 30 through 100% of the outer diameter of an inscribed circle that internally touches the outer edge of the cross sectional surface orthogonal to the axial direction of the nut body.

With such a construction, the following actions can be brought about in addition to those obtained in any one of the eighth aspect through the fourteenth aspect of the invention.

(1) Since it is not necessary to form a welding bevel when the extending portion is fixed on the top face of a nut body by welding, welding is facilitated, and excellent work efficiency can be obtained.

(2) Since the outer diameter of the extending portion is formed to be 30 through 100% of the outer diameter of an inscribed circle that internally touches the outer edge of the cross sectional surface orthogonal to the axial direction of the nut body, and the outer diameter of the extending portion is smaller than the nut body, no extending portion becomes an obstacle when tightening the nut body by using a wrench, etc., and the wrench can be easily inserted into the nut body. Accordingly, tightening work efficiency is excellent.

Herein, a polygonal shape is employed as the outer edge of the cross sectional surface orthogonal to the axial direction of the nut body where the nut body is formed to be a polygonal-shaped nut like a square-shaped member or a hexagonal-shaped member, and a circular shape is employed where the nut body is formed to be a round nut.

It is preferable that the outer diameter of the extending portion is 30 through 100% of the outer diameter of an inscribed circle which internally touches the outer edge of the cross sectional surface orthogonal to the axial direction of the nut body. If the outer diameter thereof becomes smaller than 30%, there is a tendency by which the extending portion is made slender and it becomes difficult for the sub female screw thread portion to be formed. If the outer diameter thereof becomes larger than 100%, the extending portion becomes an obstacle when tightening the nut body by using a wrench and the like, and it becomes difficult to tighten the nut body, wherein the tightening efficiency is worsened. Therefore, it is not preferable.

A method for producing a loosening-stop nut having a structure of a loosening-stop tightening means, according to the sixteenth aspect of the invention, which is screwed in a male screw thread of a bolt and the like and tightens a member to be tightened, is a method for producing a loosening-stop nut having a structure of a loosening-stop tightening means according to the first aspect of the invention. The method comprises the steps of: (a) forming a nut-annular groove portion on the inner-circumferential wall of an extending portion formed integrally with a nut body or fixed at the nut body, and simultaneously forming a female screw thread, the pitch of which is the same as that of the male screw thread, on the inner-circumferential wall of the nut body or the extending portion, or (b) forming a nut-annular groove portion at a prescribed portion of the inner-circumferential wall of a nut and forming a nut body and an extending portion on the nut; and forming a nut-resilient portion by deforming the extending portion at the nut-annular groove portion formed in the inner circumferential wall forming step with a prescribed load applied between the bearing surface of the nut body and the top face of the extending portion for a prescribed period of time so that, where it is assumed that the size of a pitch of the female screw thread is P′, a γ amount of deformation becomes (n+1/30)P′≦γ≦(n+5/18)P′, preferably (n+1/15)P′≦γ≦(n+¼)P′, further preferably (n+1/15)P′≦γ≦(n+⅕)P′, or (n−5/18)P′≦γ≦(n−1/30)P′, preferably (n−¼)P′≦γ≦(n−1/15)P′, or further preferably (n−⅕)P′≦γ≦(n−1/15)P′, (however, n is an integral number more than 0, and γ is positive in the compressing direction and negative in the tensile direction).

With such a construction, the following actions can be brought about.

(1) By deforming the nut-annular groove portion after a female screw thread is formed on the inner circumferential wall, it is possible to easily form a main female screw thread portion and a sub female screw thread portion, the phases of which slip, wherein production can be facilitated, and productivity is excellent.

(2) Since, by forming the γ amount of deformation of the nut-annular groove portion with a prescribed range, it is possible to securely displace the phase of the sub female screw thread portion with respect to the main female screw thread portion by 12 through 100°, preferably 24 through 90°, or further preferably 24 through 72°, whereby excellent reliability and excellent work efficiency can be brought about.

Herein, the step of forming an inner circumferential wall forms a nut-annular groove portion and a female screw thread by cutting work using a lathe or a milling machine, on the inner-circumferential wall of a member in which the nut body and extending portion are integrally formed by a plasticizing process such as press molding and a cutting process or on the inner-circumferential wall of a member in which the extending portion is fixed at the nut body by welding such as resistance welding and friction welding and fitting and is extended coaxially with the nut body. Or the above-described step forms a nut-annular groove portion on the inner-circumferential wall of a nut having a female screw thread formed by cutting using a lathe or a milling machine and separates the female screw thread, and forms the nut body and extending portion.

The step of forming a nut-resilient portion applies a prescribed load between the bearing surface of the nut body and the top face of the extending portion by using a pressing device for a prescribed period of time. It is preferable that the load is applied in a cold state, wherein the mechanical strength can be improved, and high dimensional accuracy can be obtained.

A method for producing a loosening-stop nut having a structure of a loosening-stop tightening means, according to the seventeenth aspect of the invention, which is screwed in the male screw thread of a bolt and the like and tightens a member to be tightened, is a method for producing a loosening-stop nut having a structure of a loosening-stop tightening means according to the first aspect of the invention. The method comprises the steps of: forming the nut body and extending portion integrally or fixing an extending portion at the nut body and extending the extending portion coaxially with the top face of the nut body; forming a nut-annular groove portion at a prescribed part of the inner circumferential wall of the extending portion formed integrally with the nut body or fixed at the nut body in the body forming step, forming a main female screw thread portion on the inner circumferential wall of the nut body, and simultaneously forming a sub female screw thread portion on the inner circumferential wall of the extending portion so that the phase thereof with respect to the main female screw thread portion is displaced by 12 through 100°, preferably 24 through 90°, or further preferably 24 through 72° from the nut-annular groove portion toward the top face of the extending portion.

With such a construction, the following actions can be brought about.

(1) Since the method includes a step of forming, by screwing a sub screw thread portion with a lathe, a screw thread groove portion in which the phase of the sub female screw thread portion with respect to the main female screw thread portion is displaced, no press facility used for compression deformation is required, wherein the facility cost can be suppressed.

Herein, the body forming step forms the nut body and extending portion integrally with each other by a plastic forming such as a press molding process or cutting work, or to provide the extending portion coaxially with the nut body by fixing the extending portion on the nut body by welding such as resistance welding and friction welding or fitting the same together. The nut body and extending portion, which are used in the body forming step does not have any female screw thread and nut-annular groove portion formed on the inner-circumferential wall.

The step of forming a screw thread groove portion forms a nut-annular groove portion, a main female screw thread portion, and a sub female screw thread portion on the inner circumferential wall by cutting work using a lathe or milling machine.

A method for producing a loosening-stop nut having a structure of a loosening-stop tightening means, according to the eighteenth aspect of the invention, which is screwed in the male screw thread of a bolt and the like and tightens a member to be tightened, is a method for producing a loosening-stop nut having a structure of a loosening-stop tightening means according to the first aspect of the invention. The method comprises the steps of: forming an extending portion, on which a nut-annular groove portion is formed, at a prescribed part of the inner circumferential wall thereof; fixing the extending portion formed by the extending portion forming step on the top face of a nut body; forming a female screw thread with the same pitch and phase as those of the male screw thread on the inner circumferential wall of the nut body, on which the extending portion is fixed in the extending portion fixing step, and on the inner circumferential wall of the extending portion; and forming a nut-resilient portion by deforming the extending portion at the nut-annular groove portion with a prescribed load applied between the bearing surface of the nut body, on which the female screw thread is formed in the female screw thread forming step, and the top face of the extending portion for a prescribed period of time so that, where it is assumed that the size of a pitch of the female screw thread is P′, a γ amount of deformation becomes (n+1/30)P′≦γ≦(n+5/18)P′, preferably (n+1/15)P′≦γ≦(n+¼)P′, further preferably (n+1/15)P′≦γ≦(n+⅕)P′, or (n−5/18)P′≦γ≦(n−1/30)P′, preferably (n−¼)P′≦γ≦(n−1/15)P′, or further preferably (n−⅕)P′≦γ≦(n−1/15)P′, (however, n is an integral number more than 0, and γ is positive in the compressing direction and negative in the tensile direction).

With such a construction, the following actions can be brought about in addition to those described in the sixteenth aspect of the invention.

(1) Since the method includes a step of forming an extending portion, the extending portion and nut-annular groove portion can be freely designed, wherein the degree of freedom in design can be increased.

Herein, the step of forming an extending portion forms a nut-annular groove portion at the extending portion by a plastic forming such as a press molding process, and a cutting process.

The step of fixing an extending portion fixes an extending portion at the nut body by welding such as resistance welding, friction welding and fusion welding or fitting and provides an extending portion coaxially with the nut body. In particular, resistance welding is preferable, which welds a contacting portion between the nut body and the extending portion by generating resistance heat at the contacting portion by causing a direct current or an alternate current to flow between the nut body and the extending portion, because the resistance welding scarcely occurs any thermal deformation and is superior in view of reliability. Of the resistance welding, in particular, projection welding is preferably utilized, which carries out welding by causing a projection formed at a welding portion and causing a current to flow thereto, because the projection welding scarcely overheat the welding portion and is superior in view of safety.

The step of forming a female screw thread forms a female screw thread on the inner circumferential wall by cutting work using a lathe or a milling machine.

The step of forming a nut-resilient portion is similar to that described in the sixteenth aspect of the invention, and a description thereof is omitted.

A method for producing a loosening-stop nut having a structure of a loosening-stop tightening means, according to the nineteenth aspect of the invention, which is screwed in the male screw thread of a bolt and the like and tightens a member to be tightened, is a method for producing a loosening-stop nut having a structure of a loosening-stop tightening means according to the first aspect of the invention. The method comprises the steps of: forming an extending portion having a nut-annular groove portion formed at a prescribed part of the inner circumferential wall thereof; fixing the extending portion formed in the extending portion forming step on the top face of a nut body; and forming a main female screw thread portion on the inner circumferential wall of the nut body on which the extending portion is fixed in the extending portion fixing step, and simultaneously forming a sub female screw thread portion on the inner circumferential wall of the extending portion so that the phase thereof with respect to the main female screw thread portion is displaced by 12 through 100°, preferably 24 through 90°, or further preferably 24 through 72° from the nut-annular groove portion toward the top face of the extending portion.

With such a construction, the actions described in the seventeenth aspect to the eighteenth aspect of the invention can be brought about.

Herein, the step of forming a female screw thread portion forms a main female screw thread portion and a sub female screw thread portion on the inner circumferential wall by cutting work using a lathe and a milling machine.

The step of forming an extending portion and step of fixing the extending portion are similar to those described in the eighteenth aspect of the invention, and a description thereof is omitted.

A method for producing a loosening-stop nut having a structure of a loosening-stop tightening means, according to the twentieth aspect of the invention, which is screwed in the male screw thread of a bolt and the like and tightens a member to be tightened, is a method for producing a loosening-stop nut having a structure of a loosening-stop tightening means according to the first aspect. The method comprises the steps of: forming an extending portion having a nut-annular groove portion formed at a prescribed part of the inner circumferential wall thereof, and next forming a nut-resilient portion by deforming the extending portion at the nut-annular groove portion with a prescribed load applied roughly in parallel to the axial direction of the extending portion for a prescribed period of time so that, where it is assumed that the size of a pitch of the female screw thread is P′, a γ amount of deformation becomes (n+1/30)P′≦γ≦(n+5/18)P′, preferably (n+1/15)P′≦γ≦(n+¼)P′, further preferably (n+1/15)P′≦γ≦(n+⅕)P′, or (n−5/18)P′≦γ≦(n−1/30)P′, preferably (n−¼)P′≦γ≦(n−1/15)P′, or further preferably (n−⅕)P′≦γ≦(n−1/15)P′, (however, n is an integral number more than 0, and γ is positive in the compressing direction and negative in the tensile direction); fixing the extending portion formed in the extending portion deforming step on the top face of the nut body; and forming a main female screw thread portion on the inner circumferential wall of the nut body on which the extending portion is fixed in the extending portion fixing step; and simultaneously forming a sub female screw thread portion on the inner circumferential wall of the extending portion so that the phase thereof with respect to the main female screw thread portion is displaced by 12 through 100°, preferably 24 through 90°, or further preferably 24 through 72° from the nut-annular groove portion toward the top face of the extending portion.

With such a construction, the following actions can be brought about.

(1) Since the step of forming an extending portion is provided, it is possible to freely form the profiles of the extending portion and nut-annular groove portion, and at the same time, the nut-resilient portion can be molded. Therefore, it is possible to provide a method for producing a loosening-stop nut, which has a high degree of freedom.

Herein, the step of deforming an extending portion forms a nut-annular groove portion at the extending portion by a plastic forming such as a press-molding step and a cutting process, and next applies a prescribed load in parallel to the axial direction of the extending portion using a pressing device for a prescribed period of time. It is preferable that the load is applied in a cold state, wherein the mechanical strength is improved, and simultaneously, high dimensional accuracy can be secured.

The step of fixing the extending portion is similar to that described in the eighteenth aspect of the invention, and the step of forming a female screw thread portion is similar to that described in the nineteenth aspect of the invention. Therefore, a description thereof is omitted.

### BRIEF DESCRIPTION OF THE DRAWINGS

FIG. 1(a) is a perspective view of the entire loosening-stop bolt according to Embodiment 1, and FIG. 1(b) is a sectional end face view of the major parts in the axial direction of FIG. 1(a);

FIG. 2(a) is a sectional end face view of the major parts showing a state before the bolt-annular groove portion of the loosening-stop bolt according to Embodiment 1 is compressed and deformed, and FIG. 2(b) is a sectional view of a bolt, in which the bolt is formed, the bolt tip end portion and tip end recess are formed;

FIG. 3 is a sectional end face view of the major parts showing a modified version of the loosening-stop bolt according to Embodiment 1;

FIG. 4 is a sectional view of the major parts showing a state where a member to be tightened is tightened by a loosening-stop bolt according to Embodiment 1;

FIG. 5 is an exemplary view showing a relationship between a force and displacement, which are produced at the bolt-resilient portion when a member to be tightened is tightened by a loosening-stop bolt according to Embodiment 1;

FIG. 6 is a sectional view showing a state where a member to be tightened is tightened by a loosening-stop bolt according to Embodiment 2;

FIG. 7 is an exemplary view showing a relationship between stress and distortion, which are applied to the main female screw thread portion and sub female screw thread portion when a member to be tightened is tightened by a loosening-stop bolt according to Embodiment 2;

FIG. 8(a) is a perspective view showing the entire loosening-stop nut according to Embodiment 3, and FIG. 8(b) is a sectional end face view of the major parts taken along the line A-A in FIG. 8(a);

FIG. 9 is a sectional end face view of the major parts showing a state where a nut-annular groove portion of a loosening-stop nut according to Embodiment 3 is compressed and deformed;

FIG. 10 is a sectional end face view of the major parts of a loosening-stop nut according to Embodiment 4;

FIG. 11 is a sectional end face view of the major parts of a loosening-stop nut according to Embodiment 5;

FIG. 12 is a sectional view of the major parts showing a state where a member to be tightened is tightened by a loosening-stop nut according to Embodiment 3.

FIG. 13 is a sectional view of the major parts showing a state where a member to be tightened is tightened by a loosening-stop nut according to Embodiment 6;

FIG. 14 is a sectional end face view of the major parts of a loosening-stop nut according to Embodiment 7;

FIG. 15 is a sectional end face view of the major parts of a loosening-stop nut according to Embodiment 8;

FIG. 16(a) is a sectional view of the major parts showing a step of forming an extending portion in a method for producing a loosening-stop nut according to Embodiment 9;

FIG. 16(b) is a sectional view of the major parts showing a step of fixing an extending portion in a method for producing a loosening-stop nut according to Embodiment 9;

FIG. 16(c) is a sectional view of the major parts showing a step of forming a female screw thread in a method for producing a loosening-stop nut according to Embodiment 9;

FIG. 16(d) is a sectional view of the major parts showing a step of forming a nut-resilient portion in a method for producing a loosening-stop nut according to Embodiment 9;

FIG. 17 is a sectional view of the major parts showing an application example of the extending portion and nut body; and

FIG. 18 is an exemplary view showing the conditions of a vibration test.

### DESCRIPTION OF EMBODIMENTS OF THE INVENTION

Hereinafter, a description is given of an embodiment of the invention with reference to the accompanying drawings.

(Embodiment 1)

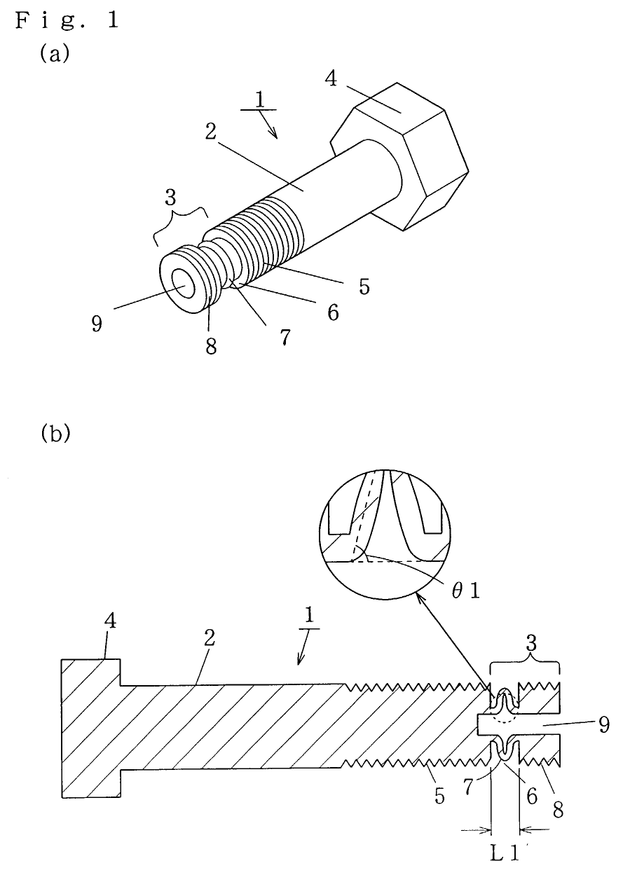

FIG. 1(a) is a perspective view of the entirety of a loosening-stop bolt according to Embodiment 1, and FIG. 1(b) is a sectional end face view of the major parts thereof in the axial direction of FIG. 1(a);

In the drawings, a loosening-stop bolt 1 operates as a loosening-stop tightening means of Embodiment 1. A bolt shank 2 operates as a tightening means body of the loosening-stop bolt 1. A bolt tip end portion 3 is formed at the tip end of the bolt shank 2 integrally and coaxially with the bolt shank 2. A bolt head 4 is formed to be a hexagonal member at the bolt shank 2 at the opposite side of the bolt tip end portion 3. A main male screw thread portion 5 operates as the main screw thread portion which is formed to be a triangular screw thread, trapezoidal screw thread, square screw thread, serrated screw thread, etc., (the drawing shows a triangular screw thread) of a single-start type or a multiple-start type on the outer circumference of the bolt shank 2 at the tip end side. A bolt-annular groove portion 6 acts as an annular groove portion which is formed with the same depth as the root of the main male screw thread portion 5 or deeper than the root thereof on the outer circumference side at the bolt shank 2 side of the bolt tip end portion 3. A bolt-resilient portion 7 is swelled to the outer circumference of the bolt tip end portion 3 or is compressed in the axial direction wherein, where it is assumed that the size of a pitch of the main male screw thread portion 5 is P, the bolt tip end portion 3 at the bolt-annular groove portion 6 is compressed and deformed so that an α amount of deformation of the bolt-annular groove portion in the axial direction is (n+1/30)P′≦α≦(n+5/18)P, preferably (n+1/15)P≦α≦(n+¼)P, further preferably (n+1/15)P≦α≦(n+⅕)P, or (n−5/18)P≦α≦(n−1/30)P, preferably (n−¼)P≦α≦(n−1/15)P, or further preferably (n−⅕)P≦α≦(n−1/15)P, (however, n is an integral number more than 0, and α is positive in the compressing direction and negative in the tensile direction). Also, the bolt-resilient portion may be formed to be made thin by tensile deformation. A sub male screw thread portion 8 acts as a sub screw thread portion which is formed with the same pitch as that of the main male screw thread portion 5 on the outer circumference of the bolt tip end portion 3 excepting for the bolt-annular groove portion 6. A tip end recessed portion 9 is formed from the bolt tip end portion 3 to a part of the bolt shank 2 beyond the entire width of the bolt-annular groove portion 6 around the axial center of the bolt tip end portion 3. L1 denotes a length of the bolt-annular groove portion 6 (bolt-resilient portion 7) compressed by compressed deformation, and θ1 is an angle of deformation of the bolt-resilient portion 7 with respect to the axial direction.

A description is given of a method for producing a loosening-stop bolt in Embodiment 1 that is constructed as described above, with reference to the accompanying drawings.

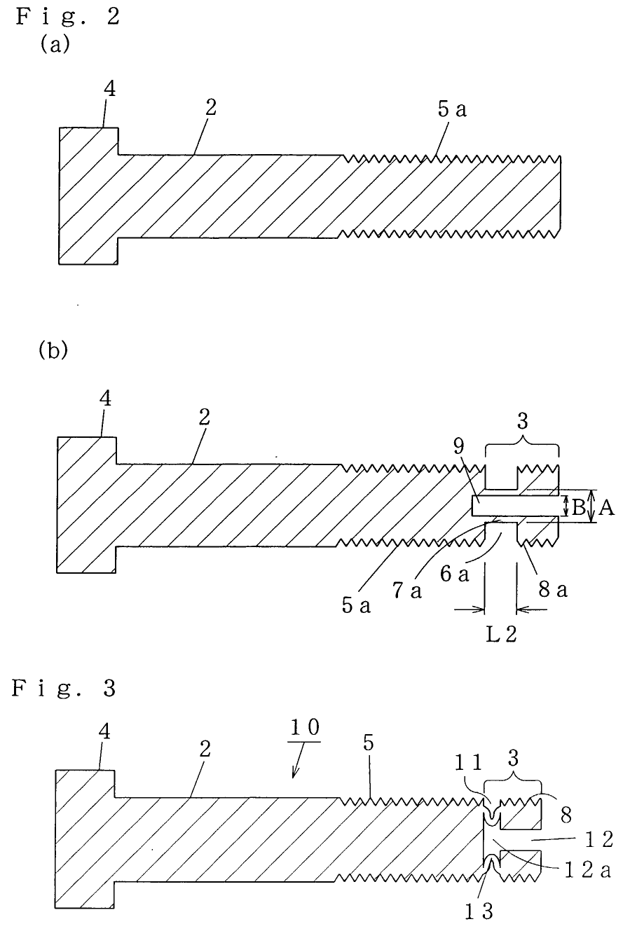

FIG. 2(a) is a cross sectional end face view of the major parts showing a state before the bolt-annular groove portion of a loosening-stop bolt in Embodiment 1 is deformed by compression, and FIG. 2(b) is a cross sectional view of a bolt machined, on which a bolt tip end portion and a tip end recessed portion are formed.

In FIG. 2(a), a male screw thread 5a is formed to be a triangular-screw thread of a single-start type through a multiple-start type on the outer circumference of the bolt shank 2.

In FIG. 2(b), a bolt-annular groove portion 6a is formed to be annular on the outer circumference at the bolt shank 2 side of the bolt tip end portion 3. 7a denotes the shank of the bolt-annular groove portion 6a, and a male screw thread 8a is formed to be separate from the male screw thread 5a by the bolt-annular groove portion 6a. A denotes the outer diameter of the bolt-annular groove portion 6a, and B denotes the inner diameter of the tip end recessed portion 9. L2 denotes the length of the bolt-annular groove portion 6a in the axial direction before deformation by compression. The male screw threads 5a and 8a are formed with the same pitch and phase as those of the female screw thread to be screwed with.

In Embodiment 1, the length L2 of the bolt-annular groove portion 6a in the axial direction before deformation by compression is formed at a dimension of P≦L2≦5P +A−B (However, P is the size of pitch of the male screw threads 5a and 8a). Also, the cross sectional area π. (A²−B²)/4 of the shank 7a is formed to be 5% through 50% of the cross sectional area at the root (the root of the male screw thread 5a) of the bolt shank 2. Further, the angle θ1 (Refer to FIG. 1(b)) of the bolt-resilient portion 7 is formed by the relationship of L2=L1/cos θ1 at 10≦θ1≦75°.

First, in the step of forming the body, the bolt shank 2, with which a male screw thread 5a and the bolt head 4 are formed integrally is screwed, is formed by a plastic forming such as a press molding process or a cutting process (See FIG. 2).

Next, in the step of forming a bolt-annular groove portion, the bolt-annular groove portion 6a, which is slightly deeper than the root of the male screw thread 5a, is formed on the outer circumference at a prescribed part at the tip end side of the bolt shank 2, thereby forming the bolt tip end portion 3.

Next, in the step of forming a tip end recessed portion, the tip end recessed portion 9 is drilled deeply and formed from the tip end of the bolt tip end portion 3 to a part of the bolt shank 2 beyond the width of the bolt-annular groove portion 6a around the axis of the bolt tip end portion 3 (See FIG. 2(b)).

Next, in the step of forming a bolt-resilient portion, a larger load than the buckling load of the bolt tip end portion 3 at the bolt-annular groove portion 6 is applied roughly in parallel to the bolt shank 2 between the tip end of the bolt tip end portion 3 and the bolt head 4 for a prescribed period of time, whereby the bolt-resilient portion 7 is formed by compressing and deforming the bolt tip end portion 3 at the bolt-annular groove portion 6 so that the α amount of deformation becomes (n+1/30)P≦α≦(n+5/18)P, preferably (n+1/15)P≦α≦(n+¼)P, further preferably (n+1/15)P≦α≦(n+⅕)P, or (n−5/18)P≦α≦(n−1/30)P, preferably (n−¼)P≦α≦(n−1/15)P, or further preferably (n−⅕)P≦α≦(n−1/15)P, (however, P is the pitches of male screw threads 5a and 8a, n is an integral number more than 0, and α is positive in the compressing direction and negative in the tensile direction). As a result, the male screw thread 5a becomes the main male screw thread portion 5, and the male screw thread 8a becomes the sub male screw thread portion 8, the phase of which with respect to the main male screw thread portion 5 is displaced by 12° through 100°, preferably 24° through 90° or further preferably 24° through 72°. (See FIG. 1(b)).

In addition, in the present embodiment, although a description has been given of a case where the bolt head 4 and bolt shank 2 are formed to be integral with each other by a plastic forming such as a press molding process and a cutting process, and the bolt-annular groove portion 6a is formed on the bolt shank 2, it is possible to form the bolt tip end portion 3 coaxially with the bolt shank 2 by forming the bolt tip end portion 3 in which the bolt-annular groove portion 6a is formed in advance, and fixing on the tip end of the bolt shank 2 by welding such as resistance welding and friction resistance, and fitting. In this case, the tip end recessed portion 9 may be formed on the bolt tip end portion 3 in advance, or it may be drilled and formed after the bolt tip end portion 3 is fixed at the bolt shank 2.

Also, although a description has been given of a case where, after the bolt-annular groove portion 6a is formed in the step of forming the bolt-annular groove portion, the tip end recessed portion 9 is formed in the step of forming the tip end recessed portion, there is a case where, after the tip end recessed portion 9 is formed in the step of forming the tip end recessed portion, the bolt-annular groove portion 6a is formed in the step of forming the bolt-annular groove portion. In this case, an action similar thereto may be obtained.

Also, in the step of forming a bolt-resilient portion, there is a case where the bolt-annular groove portion 6a is twisted and is deformed by compression or deformed by tension by only the α amount of deformation. In this case, similar effects can be brought about.

Next, a description is given of a modified version of a loosening-stop bolt according to Embodiment 1 with reference to the following drawings.

FIG. 3 is a cross sectional end face view of the major parts showing the modified version of a loosening-stop bolt according to Embodiment 1.

In the drawing, 10 denotes a loosening-stop bolt of the modified version according to Embodiment 1. A bolt-annular groove portion 11 is formed to be annular roughly orthogonal to the axial direction of the bolt shank 2 at the same depth as the root of the main male screw thread portion 5 on the outer circumference at the bolt shank 2 side of the bolt tip end portion 3. A tip end recessed portion 12 is drilled and formed from the tip end of the bolt tip end portion 3 centering around the axis of the bolt tip end portion 3. 12a denotes a large diameter recessed portion of the tip end recessed portion 12, which is formed with a larger diameter than the inner diameter of the tip end recessed portion 12, at the bolt tip end portion 3 inside the bolt-annular groove portion 11. A bolt-resilient portion 13 is swelled inside the large diameter recessed portion 12a by compressing and deforming the bolt tip end portion 3 at the bolt-annular groove portion 11 so that the α amount of deformation becomes (n+1/30)P≦α≦(n+5/18)P, preferably (n+1/15)P≦α≦(n+¼)P, further preferably (n+1/15)P≦α≦(n+⅕)P, or (n−5/18)P≦α≦(n−1/30)P, preferably (n−¼)P≦α≦(n−1/15)P, or further preferably (n−⅕)P≦α≦(n−1/15)P, (however, P is the pitch of the main male screw thread portion 5, n is an integral number more than 0, and α is positive in the compressing direction and negative in the tensile direction).

As shown in the modified version, it is possible to swell the bolt-resilient portion not only to the outer circumferential side of the bolt tip end portion but also to the inside of the tip end recessed portion. Also, in this case, in the step of forming the bolt-resilient portion, the outer circumferential side may be restricted so that the bolt-resilient portion is swelled inside the tip end recessed portion.

Next, a description is given of actions of the loosening-stop bolt according to Embodiment 1, which is constructed as described above, when using the bolt, with reference to the following drawings.

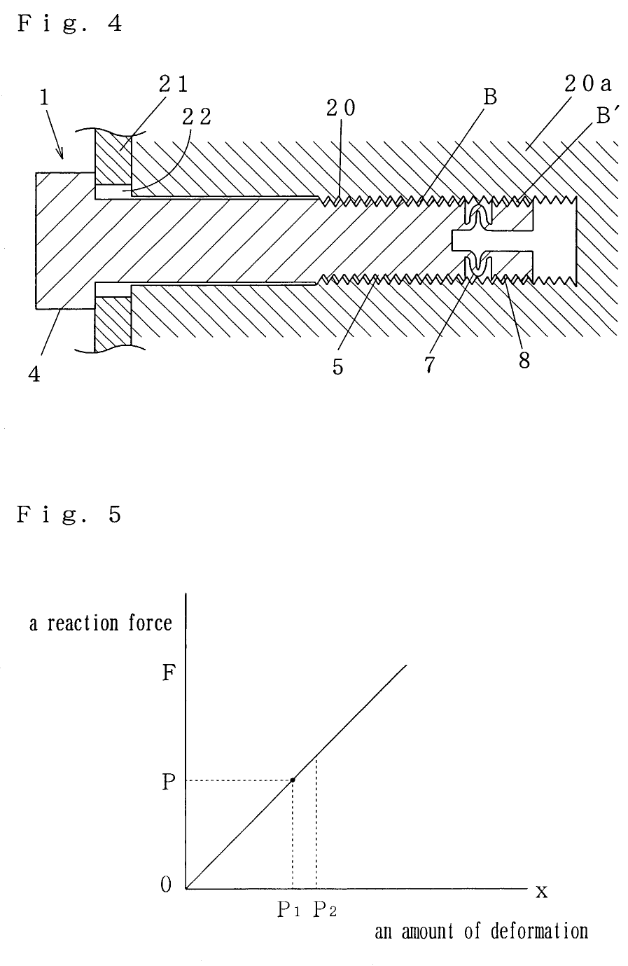

FIG. 4 is a cross sectional view of the major parts showing the loosening-stop bolt in Embodiment 1 in a state where a member to be tightened is tightened, FIG. 5 is an exemplary view showing the relationship between a reaction force and displacement, which are produced at the bolt-resilient portion, when the member to be tightened is tightened by the loosening-stop bolt according to Embodiment 1, wherein the ordinate indicates a reaction force produced at the bolt-resilient portion, and the abscissa indicates an amount of deformation of the bolt-resilient portion.

In FIG. 4, a female screw thread 20 is screwed at a prescribed part of a plate-shaped or ore-shaped structure 20a. A member 21 to be tightened is tightened at the structure 20a with the loosening-stop bolt 1. A bolt hole 22 is drilled in the member 21 to be tightened, through which the loosening-stop bolt 1 is inserted. Also, in the drawings, B denotes clearance (backlash) that is formed by play due to unevenness in machining accuracy at a screwed part between the main male screw thread portion 5 and the female screw thread 20, and B′ shows a backlash that is formed at the screwed portion of the sub male screw thread portion 8 and the female screw thread 20. The backlashes B and B′ are generated in directions opposite to each other.

Where the member 21 to be tightened is tightened by a loosening-stop bolt 1, the loosening-stop bolt 1 is inserted into a bolt hole 22 of the member 21, and as shown in FIG. 4, the loosening-stop bolt 1 is screwed in a female screw thread 20, deformation equivalent to a differential (0P₁ shown in FIG. 5) between the amount of deformation (equivalent to 0P₂ in FIG. 5) corresponding to a phase shift between the female screw thread 20 and the sub male screw thread portion 8, which is produced by the α amount of deformation of the bolt-resilient portion 7 in the axial direction and the amount of deformation (equivalent to P₁P₂ in FIG. 5) corresponding to a length of the backlash B or B′ in the axial direction is brought about at the bolt-resilient portion 7, and a reaction force (Point P indicated in FIG. 5) in line with the resilient deformation of the bolt-resilient portion 7 is produced. By the reaction force (P) produced in the bolt-resilient portion 7, the flanks of the sub male screw thread portion 8 and main male screw thread portion 5 are firmly adhered to each other by pressing the flank of the female screw thread 20 in the normal and reverse directions.

If the loosening-stop bolt 1 that is once screwed in the female screw thread 20 is removed, the reaction force produced in the bolt-resilient portion 7 becomes zero, and at the same time, the displacement also becomes zero by a restoration force of the bolt-resilient portion 7. If the removed loosening-stop bolt 1 is screwed in the female screw thread 20 again, the flanks of the sub male screw thread portion 8 and main male screw thread portion 5 are firmly adhered to each other by the female screw thread 20, wherein it is possible to repeatedly tighten the member 21.

Since the loosening-stop bolt according to Embodiment 1 is constructed as described above, the following actions can be brought about.

(1) Since the loosening-stop bolt which is screwed in a female screw thread is such that the phase of the sub male screw thread portion with respect to the main male screw thread portion is displaced by a prescribed amount, the direction along which the flank of the main male screw thread portion is brought into contact with the flank of a female screw thread due to contact pressure generated by the tightening force differs by 180° from the direction along which the flank of the sub male screw thread portion is brought into contact with the flank of a female screw thread. That is, the directions run counter to each other. Therefore, the direction of a torque produced by the contact pressure and lead angle of the screw thread at the main male screw thread portion differs in terms of plus and minus from the direction thereof at the sub male screw thread portion, wherein if an external force such as vibrations is applied to a nut and a member to be tightened, and a force operating along the turning direction along which the main male screw thread portion is likely to be loosened from the female screw thread is added, a torque produced at the flank of the sub male screw thread portion operates in the tightening direction. Accordingly, it is possible to securely prevent the loosening-stop bolt from being loosened from the female screw threads, and a high tightening force can be semi-permanently maintained.

(2) Since a sub male screw thread portion is provided on the outer circumference of the tip end portion of the bolt, which is formed so that the phase thereof with respect to the main male screw thread portion is displaced by 12 through 100°, preferably 24 through 90° or further preferably 24 through 72°, a reaction force with which the sub male screw thread portion presses the female screw thread in the direction of the main male screw thread portion, and a reaction force with which the main male screw thread portion presses the female screw thread in the direction of the sub male screw thread portion, or a reaction force with which the sub male screw thread portion presses the female screw thread in the direction opposite to the main male screw thread portion, and a reaction force with which the main male screw thread portion presses the female screw thread in the direction opposite to the sub male screw thread portion are produced by screwing a loosening-stop bolt in the female screw thread when tightening a member to be tightened, whereby a large friction force can be obtained between the main male screw thread portion or the sub male screw thread portion and the female screw thread, and it is possible to securely prevent the screwing force from being lowered due to a loosening of the main male screw thread portion, etc., from the female screw thread due to vibrations. Also, since the amount of deformation is smaller than a conventional example, it is possible to easily screw with small resistance when screwing.

(3) If a tightening force is added by screwing the loosening-stop bolt in a female screw thread, the sub male screw thread portion of the loosening-stop bolt is deformed by tightening of the female screw thread to cause resilient deformation, wherein the main male screw thread portion and sub male screw thread portion can be more firmly adhered and tightened to the female screw thread portion by the reaction force in resilient deformation, it is possible to improve the screwing force between the loosening-stop bolt and the female screw thread. Herein, the screwing force of the loosening-stop bolt and female screw thread can be further increased, and it is possible to further securely prevent the loosening-stop bolt from being loosened from the female screw thread due to an external force such as vibrations.

(4) Even in a case where any loosening is produced by wearing between a member to be tightened and the bearing surface, it is possible to prevent the loosening-stop bolt from slipping off the female screw thread by a reaction force by which the sub male screw thread portion presses the female screw thread in the direction of the main male screw thread portion or a reaction force by which the sub male screw thread portion presses the female screw thread in the direction opposite to the main male screw thread portion, wherein it is possible to prevent a falling accident, by which bolts and nuts slip out or drop therefrom, in vehicles such as automobile and tramcars in which vibrations are remarkable, and bridges.

(5) Since the main male screw thread portion and sub male screw thread portion are firmly adhered to the female screw thread by a reaction force resulting from resilient deformation which is produced by the sub male screw thread portion of the loosening-stop bolt screwed in the female screw thread being deformed by the female screw thread, play due to unevenness in machining accuracy of the female screw thread and the male screw thread portion of the loosening-stop bolt can be absorbed in resilient deformation, stability thereof is excellent, and at the same time, since the amount of displacement in the phase is slight, the screw thread portions of the loosening-stop bolt and nut are hardly impaired when being tightened, wherein since the reaction force can be obtained in a stabilized state by resilient deformation, if the female screw thread is the same one, it can be re-screwed after the loosening-stop bolt is once removed and can be repeatedly used. That is, the bolt is excellent in repeated use.

(6) Since the loosening-stop bolt has a bolt-annular groove portion formed with the same depth as the root of the main male screw thread portion or deeper than the root thereof, the main male screw thread portion can be smoothly screwed into the female screw thread when being screwed, and at the same time, deformation by compression can be facilitated by making the tip end portion of the bolt thin, wherein it is possible to prevent the main male screw thread portion, etc., from being buckled when carrying out deformation by compression.

(7) Since the bolt tip end portion at the bolt-annular groove portion is provided with a bolt-resilient portion deformed by compression, and the bolt-resilient portion has resiliency, the bolt-resilient portion can absorb play resulting from unevenness in machining accuracy of a female screw thread and a male screw thread portion of the loosening-stop bolt by elongation or contraction of the bolt-resilient portion, which is produced by the screwed female screw thread in addition to resilient deformation of the sub male screw thread portion, which is produced by the screwed female screw thread, and can increase the reaction force, which is produced by resiliency of the bolt-resilient portion, wherein it is possible to further reliably prevent the loosening-stop bolt from being loosened from the female screw thread.

(8) Since the bolt-annular groove portion can be deformed by compression after the main male screw thread portion and sub male screw thread portion are formed with the same pitch and the same phase, it is possible to easily shift the phases of the main male screw thread portion and sub male screw thread portion, and production thereof can be facilitated, wherein productivity is excellent.

(9) Since the loosening-stop bolt is provided with a tip end recessed portion, it is possible to make thin the bolt tip end portion on which the bolt-annular groove portion is formed, and compressed deformation of the bolt tip end portion can be facilitated, wherein productivity is excellent.

(10) By compressing the bolt-annular groove portion by the α amount of deformation, it is possible to securely displace the phase of the sub male screw thread portion with respect to the main male screw thread portion by 12 through 100°, preferably 24 through 90° or further preferably 24 through 72°, wherein, since the amount of deformation is adequate, the screw thread portion is not impaired when tightening, nor any seizing occurs in use, excellent repeated use can be secured. Furthermore, even if unevenness occurs in the pitch and angle of the screw thread portion, sufficient pressing contact of the flanks can be secured when tightening, and excellent stability can be brought. In addition, product yields are high, and productivity thereof is excellent.

(11) Since the bolt-annular groove portion can be set to a prescribed amount of deformation by varying the figure“n”, and the resiliency of the bolt-resilient portion can be varied as long as the deformation of the bolt-annular groove portion is within the resiliency limit, the relationship between the displacement of the bolt-resilient portion and the reaction force can be stabilized, and unevenness of the reaction force obtained is slight, wherein the stability is excellent.

(12) Since the length L2 of the bolt-annular groove portion in the axial direction before deformation by compression is within a prescribed range of P≦L2≦5P+A−B, the buckling load of the bolt-annular groove portion is made adequate, and the bolt-annular groove portion is deformed by compression, wherein the phase of the sub male screw thread portion can be easily displaced to a prescribed range. Herein, excellent productivity stability thereof can be secured.

(13) Since the length L2 of the bolt-annular groove portion in the axial direction before deformation by compression is within a prescribed range, the bolt-resilient portion can be accommodated in the bolt-annular groove portion where deformation is carried out by compression, and the bolt-resilient portion formed has an excellent degree of freedom in size, etc.

(14) Since it is possible to set the reaction force given to the female screw thread by the sub male screw thread portion by regulating the cross sectional area of the shank of the bolt-annular groove portion, loosening-stop can be achieved without impairing the female screw thread and male screw thread portion.

(15) Since the thickness of the shank of the bolt-annular groove portion is formed to be a prescribed thickness and the mechanical strength is set to a prescribed range, the phase of the sub male screw thread portion can be easily displaced in a prescribed range by deforming the bolt tip end portion. Also, adequate elongation is liable to occur at the shank of the bolt-annular groove portion, wherein since the shank is elongated when being screwed in a female screw thread, screw thread ridges of the female screw thread and sub male screw thread portion are scarcely impaired, excellent mountability can be brought about.

(16) Since the angle θ1 of the bolt-resilient portion is formed to be within a prescribed range, optimal resiliency can be obtained at the bolt-resilient portion, and at the same time, a stable relationship can be obtained between displacement and a reaction force of the bolt-resilient portion. Unevenness in reaction forces obtained is slight, and excellent stability can be achieved.

(17) Since bolts that are standardized by JIS, ASME, DIN, etc., can be processed, excellent universal use can be brought about.

Also, in Embodiment 1, although a description was given of a case where the bolt-annular groove portion 6 is compressed and deformed by only the α amount of deformation (n is an integral number including or more than 0), the α amount of deformation may be set so that, in the case where n is 0, the α amount of deformation becomes −5/18·P≦α≦−1/30·P, preferably −¼·P≦α≦−1/15·P, or further preferably −⅕·P≦α≦−1/15·P with a tensile load applied to the bolt-annular groove portion 6. In this case, similar actions can be obtained.

(Embodiment 2)

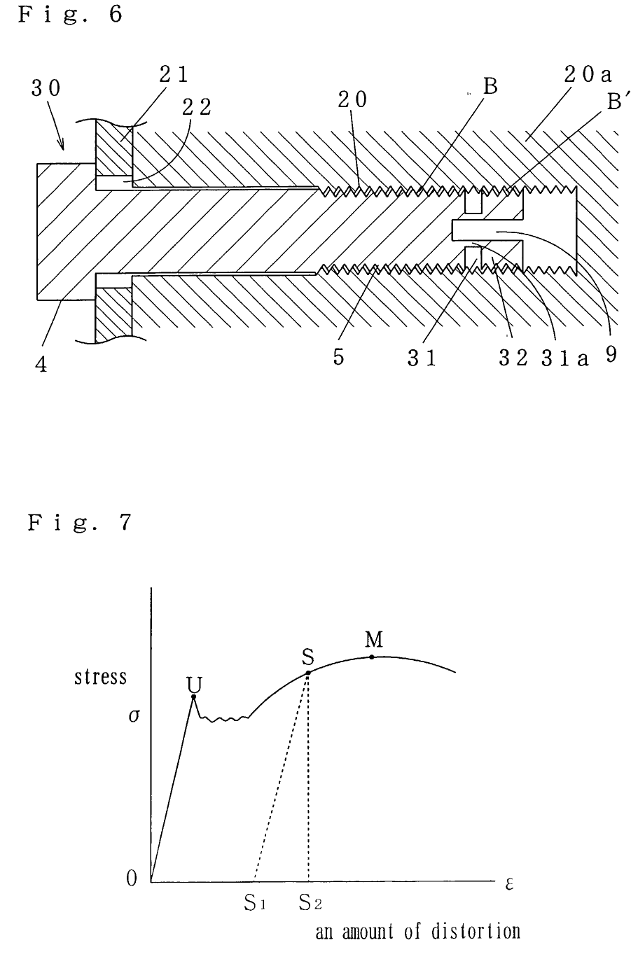

FIG. 6 is a cross sectional view of the major parts showing a state where a member to be tightened is tightened by a loosening-stop bolt according to Embodiment 2, and FIG. 7 is an exemplary view showing the relationship between stress and distortion, which are applied onto a main male screw thread portion and a sub male screw thread portion when the member to be tightened is tightened by a loosening-stop bolt according to Embodiment 2, wherein the ordinate indicates stress applied onto the main male screw thread portion and the sub male screw thread portion while the abscissa indicates an amount of distortion applied onto the main male screw thread portion and sub male screw thread portion. Herein, components which are identical to those in Embodiment 1 are given the same reference numbers, and a description thereof is omitted.

In the drawings, 30 denotes a loosening-stop bolt according to Embodiment 2. A bolt-annular groove portion 31 is formed to be annular roughly orthogonal to the axial direction of the bolt shank 2 slightly deeper than the root of the main male screw thread portion 5 on the outer circumference at the bolt shank 2 side of the bolt tip end portion 3. 31a denotes the shank of the bolt-annular groove portion 31. A sub male screw thread portion 32 is formed by screwing or rolling by a lathe, etc., with the same pitch as that of the main male screw thread portion 5 and with the phase with respect to the main male screw thread portion 5 displaced by threading using a lathe, etc., by 12 through 100°, preferably 24 through 90°, or further preferably 24 through 72°, on the outer circumference of the bolt tip end portion 3 from the bolt-annular groove portion 31 toward the tip end of the bolt tip end portion 3.

Points in which a loosening-stop bolt according to Embodiment 2 differs from that of Embodiment 1 are in that the phase of the sub male screw thread portion is not displaced by deforming the bolt-annular groove portion by compression, but the phase of the sub male screw thread portion 32 with respect to the main male screw thread portion 5 is displaced by threading using a lathe, etc., by 12 through 100°, preferably 24 through 90°, or further preferably 24 through 72°.

Even in a case where a member 21 to be tightened is tightened by a loosening-stop bolt 30, as has been described in Embodiment land as shown in FIG. 6, if a loosening-stop bolt 30 is inserted into a bolt hole 22 of the member 21, the loosening-stop bolt 30 is screwed in the female screw thread 20, stress (Point S in FIG. 7) that is larger than the resiliency limit (Point U in FIG. 7) but smaller than the extreme strength (Point M in FIG. 7) is produced at the main male screw thread portion 5 and sub male screw thread portion 32 by screw-in of the female screw thread 20, whereby the sub male screw thread portion 32 is subjected to a permanent distortion (OS1 shown in FIG. 7) and is deformed, backlashes B and B′ are produced in the normal and reverse directions at the main male screw thread portion 5 and sub male screw thread portion 32 due to unevenness, etc., in machining accuracy of the female screw thread 20, main male screw thread portion 5, and sub male screw thread portion 32. Further, since the sub male screw thread portion 32 and main male screw thread portion 5 presses the flank of the female screw thread 20 in the normal and reverse directions, these are firmly adhered to each other, and a member 21 to be tightened is sufficiently tightened.

At the loosening-stop bolt 30 that is once screwed in the female screw 20, permanent distortion (0S₁ shown in FIG. 7) is produced at the sub male screw thread portion 32 in response to the female screw thread 20 and causes the sub male screw thread portion 32 to be deformed, wherein the deformation can be maintained after the loosening-stop bolt 30 is removed from the female screw thread 20. Therefore, even in a case where the loosening-stop bolt 30 is screwed in the female screw thread 20 again, a reaction force produced by the resilient deformation (S₁ and S₂ shown in FIG. 7) of the sub male screw thread portion 32 works with the female screw thread 20, wherein the sub male screw thread portion 32 and female screw thread 20 are firmly adhered to each other, and the member 21 can be repeatedly tightened.

Since a loosening-stop bolt according to Embodiment 2 is constructed as described above, the following actions can be brought about in addition to those obtained by Embodiment 1.

(1) Since the phase of the sub male screw thread portion with respect to the main male screw thread portion (that is, the phase with respect to the female screw thread to be screwed) is displaced by threading using a lathe, etc., no press facility is required for deformation by compression, wherein facility costs can be decreased.

(2) Since the bolt tip end portion can be made thin by forming a bolt-annular groove portion and a tip end recessed portion, the mechanical strength such as resiliency and bending stress is optimized to obtain a reaction force responsive to a screw thread portion, wherein it is possible to prevent the screw thread portion from being impaired, and almost no loosening is permitted.

In a loosening-stop bolt 1 according to Embodiment 1, the reaction force that is produced by resilient deformation (S₁ and S₂ shown in FIG. 7) described in Embodiment 2 is generated in addition to the reaction force (P) produced at the bolt-resilient portion 7, wherein with the loosening-stop bolt according to Embodiment 1 as compared with that of the Embodiment 2, a larger reaction force than that of Embodiment 1 can be obtained, and a greater screwing force is obtained.

(Embodiment 3)

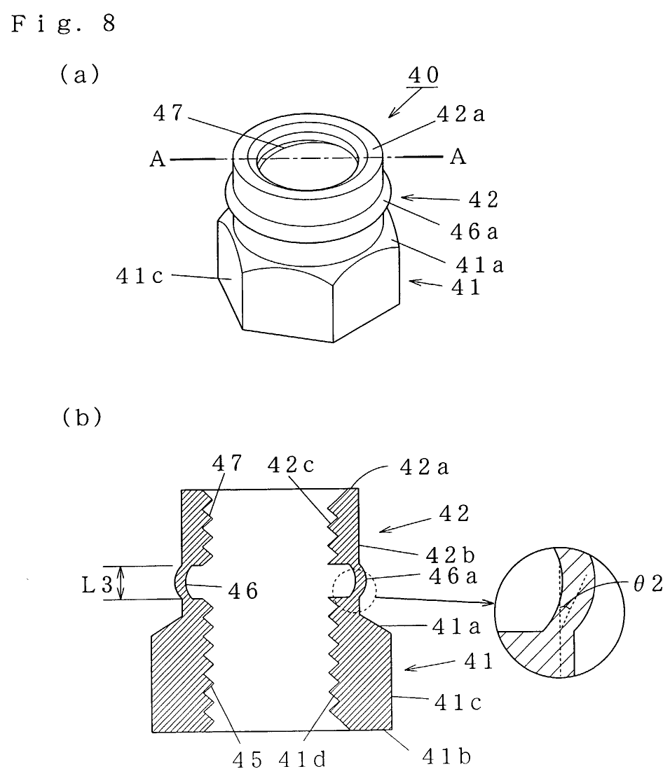

FIG. 8(a) is a perspective view of the entire loosening-stop nut according to Embodiment 3, and FIG. 8(b) is a cross sectional end face view of the major parts, which are taken along the line A-A in FIG. 8(a).

In the drawings, a loosening-stop nut 40 acts as loosening-stop means according to Embodiment 3. A nut body 41 is a tightening means body, which is formed to be hexagonal nut-shaped, of the loosening-stop nut 40. 41a denotes the top face of the nut body 41, 41b denotes the bearing surface of the nut body 41, 41c denotes the outer circumferential wall of the nut body 41, and 41d denotes the inner circumferential wall of the nut body 41. 42 denotes a cylindrical extending portion. The cylindrical extending portion 42 is formed so that the extending portion is formed integrally with the nut body 41 on the top face 41a of the nut body 41 or formed separately from the nut body 41 or fixed on the top face 41a of the nut body 41, and is caused to extend coaxially therewith, and the outer diameter of the extending portion is formed to be 30 through 100% of the outer diameter of an inscribed circle internally brought into contact with the outer edge of the section orthogonal to the axial direction of the nut body 41. 42a denotes the top face of the extending portion 42, 42b denotes the outer circumferential wall of the extending portion 42, and 42c denotes the inner circumferential wall of the extending portion 42, which is formed to be flush with the inner circumferential wall 41d of the nut body 41. A main female screw thread portion 45 operates as a main screw thread portion formed to be a triangular screw thread and a serrated screw thread of a single-start type through a multiple-start type on the inner circumferential wall 41d of the nut body 41 and the inner circumferential wall 42c of the extending portion 42. A nut-annular groove portion 46 operates as an annular groove portion which is formed to be annular in a direction roughly orthogonal to the axial direction of the extending portion 42 with a larger diameter than the root diameter of the main female screw thread portion 45 on the inner circumferential wall 42c at the nut body 41 side of the extending portion 42. A nut-resilient portion 46a is such that the extending portion 42 at the nut-annular groove portion 46 is compressed and deformed (or deformed by tension) by a length, in which, where it is assumed that the size of a pitch of the main female screw thread portion 45 is P′, a γ amount of deformation is (n+1/30)P′≦γ≦(n+5/18)P′, preferably (n+1/15)P′≦γ≦(n+¼)P′, further preferably (n+1/15)P′≦γ≦(n+⅕)P′, or (n−5/18)P′≦γ≦(n−1/30)P′, preferably (n−¼)P′≦γ≦(n−1/15)P′, or further preferably (n−⅕)P′≦γ≦(n−1/15)P′, (however, n is an integral number more than 0, and γ is positive in the compressing direction and negative in the tensile direction), swelled or recessed to the outer-circumferential wall 42b side of the extending portion 42, and compressed (or pulled) in the axial direction (The drawing shows a swelled state by deformation by compression). A sub female screw thread portion 47 acts as a sub screw thread portion formed with a single start or a multiple of starts with the same shape and pitch as those of the main female screw thread portion 45 on the inner circumferential wall 42c of the extending portion 42 from the annular groove portion 46 to the top face 42a of the extending portion 42. L3 denotes a length of the nut-annular groove portion 46 (nut-resilient portion 46a), which is deformed by compression, in the axial direction, and θ2 denotes an angle of deformation of the nut-resilient portion 46a in the axial direction.

A description is given of a method for producing a loosening-stop nut according to Embodiment 3, which is constructed as described above, with reference to the following drawings.

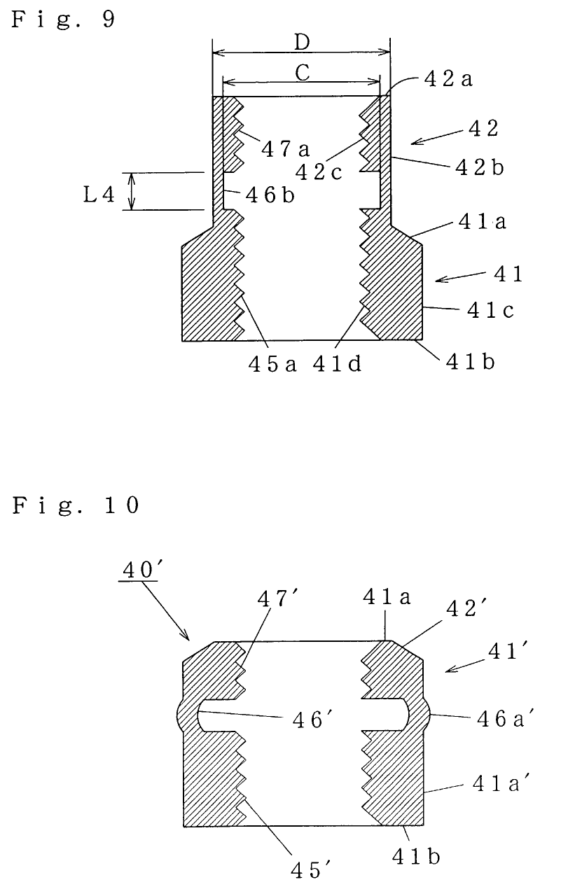

FIG. 9 is a cross sectional end face view of the major parts showing a state prior to compressing and deforming the nut-annular groove portion of a loosening-stop nut according to Embodiment 3.

In the drawing, a female screw thread 45a is formed to be a triangular screw thread, etc., of a single start through multiple starts at a part of the inner circumferential wall 41d of the nut body 41 and the inner circumferential wall 42c of the extending portion 42. A nut-annular groove portion 46b is formed annular roughly orthogonal to the axial direction of the extending portion 42 on the inner circumferential wall 42c of the nut body 41 side of the extending portion 42 with a slightly larger diameter than the root diameter of the female screw thread 45a and formed by making the extending portion 42 thin. A female screw thread 47a is formed, with the same shape and pitch as those of the female screw thread 45a, to be a triangular screw thread, etc., of a single start through multiple starts on the inner circumferential wall 42c of the extending portion 42. C denotes the inner diameter of the nut-annular groove portion 46b, D denotes the outer diameter of the extending portion 42, and L4 denotes a length of the nut-annular groove portion 46b in the axial direction before deformation by compression.

Herein, in Embodiment 3, the length L4 of the nut-annular groove portion 46b in the axial direction before deformation by compression is formed to be P′≦L4≦5P′+D−C (however, P′ is the size of pitch of the female screw threads 45a and 47a). Also, the loosening-stop nut is formed so that the angle θ2 of deformation of the nut-resilient portion 46a is 10°≦θ2 ≦75° and L4 is L3/cos θ2. Further, the cross sectional area π·(D²−C²)/4 of the extending portion 42 at the nut-annular groove portion 46b is formed to be 5 through 50% of the area of a circle whose diameter is the root diameter of the female screw threads 45a and 47a. In addition, the female screw thread 45a and female screw thread 47a are formed with the same pitch and phase as those of the male screw thread to be screwed in.

A description is given of a method for producing a loosening-stop nut, which is constructed as described above, with reference to the following drawings.

First, the nut body 41 and extending portion 42, each having no female screw thread formed, are formed integrally with each other by a plastic forming such as a press molding process and a cutting process, or the extending portion 42 is fixed at the nut body 41 by welding such as resistance welding and friction welding or fitting, and is extended coaxially with the nut body 41.

Next, in the step of forming the inner circumferential wall, a nut-annular groove portion 46b is formed on the inner circumferential wall 42c of the extending portion 42, and at the same time, a female screw thread 45a is formed at a part of the inner circumferential wall 41d of the nut body 41 and the inner circumferential wall 42c of the extending portion 42. In addition, a female screw thread 47a is formed with the same pitch and phase as those of the female screw thread 45a on the inner circumferential wall 42c of the extending portion 42 from the nut-annular groove portion 46b to the top face 42a of the extending portion 42.

Next, in the step of forming the nut-resilient portion, a larger load than the buckling load of the extending portion 42 at the nut-annular groove portion 46b is applied between the top face 42a of the extending portion 42 and the bearing surface 41b of the nut body 41 for a prescribed period of time, and the extending portion 42 at the nut-annular groove portion 46b is compressed and deformed so that, where it is assumed that the size of a pitch of the female screw thread 45a is P′, an γ amount of deformation (=L4−L3) becomes (n+1/30)P′≦γ≦(n+5/18)P′, preferably (n+1/15)P′≦γ≦(n+¼)P′, further preferably (n+1/15)P′≦γ≦(n+⅕)P′, or (n−5/18)P′≦γ≦(n−1/30)P′, preferably (n−¼)P′≦γ≦(n−1/15)P′, or further preferably (n−⅕)P′≦γ≦(n−1/15)P′, (however, n is an integral number more than 0, and γ is positive in the compressing direction and negative in the tensile direction), thereby forming the nut-resilient portion 46a. Accordingly, the female screw thread 45a becomes the main female screw thread portion 45, and the female screw thread 47a becomes the sub female screw thread portion 47, the phase of which with respect to the main female screw thread portion is displaced by 12 through 100°, preferably 24 through 90°, or further preferably 24 through 72°.

(Embodiment 4)

FIG. 10 is a cross sectional end face view of the major parts of a loosening-stop nut according to Embodiment 4. Also, components of Embodiment 4, which are identical to those in Embodiment 3, are given the same reference numbers, and a description thereof is omitted.

In the drawing, 40′ denotes a loosening-stop nut according to Embodiment 4, which is a modified version of Embodiment 3. 41′ denotes the nut body, formed like a hexagon nut, of the loosening-stop nut 40′ and having a single-start to multiple-start type female screw thread of a triangular screw thread, etc. 41a′ denotes a nut body formed at the bearing surface 41b side of a nut 41′ by a nut-annular groove portion 46′ (described later) formed on the nut 41′.

An extending portion 42′ is formed at the top face 41a side of the nut 41′ by a nut-annular groove portion 46′ (described later) formed on the nut 41′. A main female screw thread portion 45′ formed to be a triangular screw thread, etc., of a single start through multiple starts is formed on the inner-circumferential wall of the nut body 41a′. A nut-annular groove portion 46′ is formed to be annular in a direction roughly orthogonal to the axial direction of the nut 41′ with a larger diameter than the root diameter of the main female screw thread portion 45′ at a prescribed part of the inner circumferential wall of the nut 41′ (the nut body 41a′ or the extending portion 42′). A nut-resilient portion 46a′ is such that the nut 41′ at the nut-annular groove portion 46′ is compressed and deformed in the axial direction so that, where the size of a pitch of the main female screw thread portion 45′ is P′, the γ amount of deformation may be (n+1/30)P′≦γ≦(n+5/18)P′, preferably (n+1/15)P′≦γ≦(n+¼)P′, further preferably (n+1/15)P′≦γ≦(n+⅕)P′, or (n−5/18)P′≦γ≦(n−1/30)P′, preferably (n−¼)P′≦γ≦(n−1/15)P′, or further preferably (n−⅕)P′≦γ≦(n−1/15)P′, (however, n is an integral number more than 0, and γ is positive in the compressing direction and negative in the tensile direction), and is swelled out to the outer circumferential wall side of the nut 41′. The sub female screw thread portion 47′ is formed with a single start through multiple starts with the same shape and pitch as those of the main female screw thread portion 45′ on the inner circumferential wall of the extending portion 42′ from the nut-annular groove portion 46′ toward the top face 41a of the nut 41′.

Since the nut-annular groove portion 46′ is formed at a prescribed part on the inner circumferential wall of the nut 41′, and the loosening-stop nut 40′ can be formed, it is possible to easily produce the loosening-stop nut. This is suitable where the loosening-stop nut is simply produced. In particular, excellent universal use can be brought about since nuts standardized by JIS are processed.

(Embodiment 5)

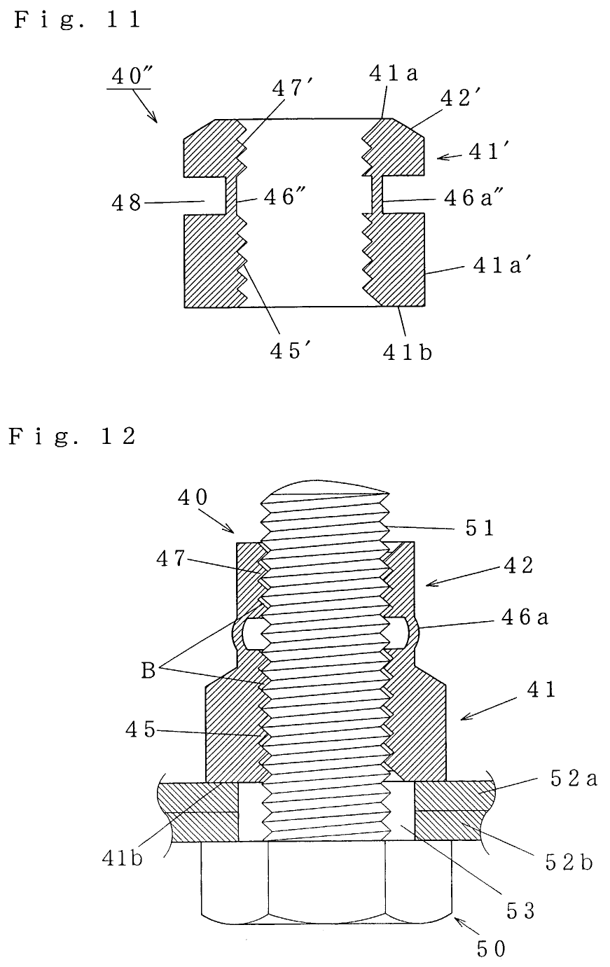

FIG. 11 is a cross sectional end face view of the major parts of a loosening-stop nut according to Embodiment 5. In addition, components in Embodiment 5, which are identical to those in Embodiment 3 or 4 are given the same reference numbers, and a description thereof is omitted.

In the drawing, 40″ denotes a loosening-stop nut according to Embodiment 5, which is another modified version of Embodiment 3. A point in which the loosening-stop nut according to Embodiment 5 differs from that of Embodiment 4 is in that a loosening-stop nut according to Embodiment 5 is provided with a nut-annular groove portion 46″ which is formed to be annular in a direction roughly orthogonal to the axial direction of the nut 41′ (the nut body 41a′ or the extending portion 42′) with the same diameter as the root diameter of the main female screw thread portion 45′ at a prescribed part of the inner circumferential wall of the nut 41′ and an outer circumferential groove portion 48 formed on the outer circumferential wall of the nut 41′ corresponding to the nut-annular groove portion 46″, the nut 41′ is deformed by tension in the axial direction, and the nut-resilient portion 46a″ is formed.

According to the present embodiment, since it is possible to easily elongate and deform the nut by making the nut thin at the outer circumferential groove portion, the nut-resilient portion 46a″ can be easily formed. Also, since the nut-resilient portion 46a″ can be accommodated in the outer circumferential groove portion 48, a wrench and the like, which is used to tighten a loosening-stop nut is scarcely brought into contact with the nut-resilient portion 46a″, wherein it is possible to prevent the nut-resilient portion 46a″ from being deformed or impaired, and it is suitable for a case where the nut-resilient portion 46a″ can be protected to increase durability.

Next, a description is given of actions when loosening-stop nuts, according to Embodiments 3 through 5, which are constructed as described above, using a loosening-stop nut according to Embodiment 3.

FIG. 12 is across sectional view of the major parts showing a state where a member to be tightened is tightened by a loosening-stop nut according to Embodiment 3. In addition, when the member to be tightened is tightened by the loosening-stop nut according to Embodiment 3, the relationship between a reaction force and displacement, which are produced at the nut-resilient portion, is described using FIG. 5 described above. In this case, the ordinate indicates a reaction force (F) produced at the nut-resilient portion, and the abscissa indicates an amount (X) of deformation of the nut-resilient portion.

In FIG. 12, 50 denotes a bolt, 51 denotes a male screw thread of the bolt 50, and 52a and 52b denote members to be tightened by the bolt 50 and loosening-stop nut 40. 53 denotes a bolt hole drilled in the members 52a and 52b, through which the bolt 50 is inserted. Also, in the drawing, B and B denote clearance (backlash) that is formed at a screwed part between the main female screw thread portion 45 or sub female screw thread portion 47 and a male screw thread 51 due to unevenness in machining accuracy of the male screw thread 51, etc., and the respective backlashes are produced in an opposite direction when the loosening-stop nut 40 is screwed to the bolt 50. Herein, a bolt 50 for which a male screw thread 51 is formed with a single start through multiple starts with the same pitch as that of the main female screw thread portion 45 and sub female screw thread portion 47 of the loosening-stop nut 40 may be used.

Where the members 52a and 52b to be tightened are tightened with a bolt 50 and a loosening-stop nut 40, if the bolt 50 is inserted through the bolt hole 53 of the members 52a and 52b and the loosening-stop nut 40 is screwed to the male screw thread 51 of the bolt 50 as shown in FIG. 12, deformation (0P₁ shown in FIG. 5) equivalent to a differential between the amount of deformation (assumed to be equal to 0P₂ in FIG. 5), in the axial direction, equivalent to a shift in phase between the male screw thread 51 and the sub female screw thread portion 47, which is produced by the γ amount of deformation in the axial direction of the nut-resilient portion 46a and the amount (assumed to be equal to P₁P₂ in FIG. 5) equivalent to a length in the axial direction of the backlash B is produced at the nut-resilient portion 46a, whereby a reaction force (P shown in FIG. 5) in line with resilient deformation of the nut-resilient portion 46a is produced. By the reaction force (P), the sub female screw thread portion 47 and the main female screw thread portion 45 are firmly tightened to each other by pressing the flank of the male screw thread 51 in the normal and reverse directions.

If the loosening-stop nut 40 which is once screwed to the bolt 50 is removed, the reaction force produced at the nut-resilient portion 46a becomes zero, and simultaneously, displacement also becomes zero by a restoration force of the nut-resilient portion 46a. Where the removed loosening-stop nut 40 is screwed to the bolt 50 again, the flanks of the sub female screw thread portion 47 of the main female screw thread portion 45 and male screw thread 51 are firmly adhered to each other by the reaction force (P) produced at the nut-resilient portion 46a, and these are repeatedly tightened.

Since a loosening-stop nut according to Embodiment 3 and a method for producing the same are constructed as described above, the following actions are brought about.

(1) Since the phase of the sub female screw thread portion with respect to the main female screw thread portion is displaced in the loosening-stop nut tightened by a male screw thread, the direction along which the flank of the main female screw thread portion is brought into contact with the flank of a male screw thread by the tightening force differs by 180° from the direction along which the flank of the sub female screw thread portion is brought into contact with the flank of a male screw thread. That is, the directions run counter to each other. Therefore, the direction of a torque produced by the contact pressure and lead angle of the screw thread at the main female screw thread portion differs in terms of plus and minus from the direction of a torque thereof at the sub female screw thread portion, wherein, if an external force such as vibrations is applied to a bolt and a member to be tightened, and a force operating along the turning direction along which the main female screw thread portion is likely to be loosened from the male screw thread is added, a torque produced at the flank of the sub female screw thread portion operates in the tightening direction. Accordingly, it is possible to securely prevent the loosening-stop nut from being loosened from the male screw threads, and a high tightening force can be semi-permanently maintained.

(2) A sub female screw thread portion formed so that the phase thereof with the main female screw thread portion is displaced by 12 through 100°, preferably 24 through 90° or further preferably 24 through 72° is provided on the inner circumferential wall of an extension portion extending on the nut body. Therefore, a reaction force with which the sub female screw thread portion presses the male screw thread in the direction of the main female screw thread portion, and a reaction force with which the main female screw thread portion presses the male screw thread in the direction of the sub female screw thread portion, or a reaction force with which the sub female screw thread portion presses the male screw thread in the direction opposite to the main female screw thread portion, and a reaction force with which the main female screw thread portion presses the male screw thread in the direction opposite to the sub female screw thread portion are produced by screwing a loosening-stop nut in the male screw thread when tightening a member to be tightened, whereby a large friction force can be obtained between the main female screw thread portion or the sub female screw thread portion and the male screw thread, it is possible to securely prevent the screwing force from being lowered due to a loosening of the main female screw thread portion, etc., from the male screw thread due to vibrations.

(3) Where a loosening-stop nut is tightened to a male screw thread such as a bolt, and a tightening force is applied thereto, the sub female screw thread portion of the loosening-stop nut is resiliently deformed by tightening of a male screw thread such as a bolt, these can be tightened so that the main female screw thread portion and sub female screw thread portion are further tightly adhered to the male screw thread by the reaction force within resilient deformation. Therefore, the screwing force of the loosening-stop nut with a male screw thread such as a bolt is increased, and it is possible to further securely prevent the loosening-stop nut from being loosened from the male screw thread such as a bolt by an external force such as vibrations.

(4) Even where wearing occurs between a member to be tightened and the bearing surface, and looseness is produced there, the loosening-stop nut can be prevented from slipping off a bolt, etc., by a reaction force by which the sub female screw thread portion presses the male screw thread in the direction of the main female screw thread portion or a reaction force by which the sub female screw thread portion presses the male screw thread in the direction opposed to the main female screw thread portion, wherein it is possible to prevent a nut and/or a bolt from falling from vehicles and bridges where vibrations of vehicles and tramcars are remarkable.

(5) Since the sub female screw thread portion of a loosening-stop nut, which is screwed with a male screw thread such as a bolt causes the main female screw thread portion and sub female screw thread portion to be tightly adhered to a male screw thread by a reaction force resulting from resilient deformation produced by the male screw thread, it is possible to absorb play due to unevenness in machining accuracy of a male screw thread such as a bolt and a female screw thread portion of a loosening-stop nut, wherein excellent stability can be secured. Also, since the amount of displacement in the phase is slight, the loosening-stop nut and screw thread portion of a bolt are scarcely impaired when tightening, wherein a stable reaction force can be obtained by resilient deformation. Therefore, if the male screw thread is the same one, it can be re-screwed after the loosening-stop nut is once removed and can be repeatedly used. That is, the bolt is excellent in repeated use.

(6) Since the loosening-stop nut has a nut-annular groove portion formed with the same diameter as the root diameter of the main female screw thread portion or with a larger outer diameter than the root diameter, the sub female screw thread portion can be smoothly screwed with a male screw thread such as a bolt.

(7) Since the nut-resilient portion in which the extending portion at the nut-annular groove portion is compressed and deformed has resiliency, play due to unevenness in machining accuracy of a male screw thread and a female screw thread portion of a loosening-stop nut is absorbed by elongation of the nut-resilient portion, which is produced by the male screw thread such as a screwed bolt, in addition to permanent deformation and resilient deformation of the sub female screw thread portion, etc., which are produced by the male screw thread such as a screwed bolt, and simultaneously a reaction force that is produced by stress generated in response to resiliency which the nut-resilient portion has can be further increased, and it is possible to prevent the loosening-stop nut from being loosened from the male screw thread such as a bolt.

(8) By deforming the nut-annular groove portion by compression or tension after the main female screw thread portion and sub female screw thread portion are formed with the same pitch and phase, it is possible to easily shift the phases of the main female screw thread portion and sub female screw thread portion, wherein production thereof can be facilitated, and excellent productivity can be achieved.

(9) Since the nut-annular groove portion can be deformed by they amount of deformation, it is possible to securely displace the phase of the sub female screw thread portion with respect to the main female screw thread portion by 12 through 100°, preferably 24 through 90°, or further preferably 24 through 75°, wherein, since the amount of deformation is adequate, screw thread portions are not impaired when tightening and seizing is scarcely produced in use, excellent repeated use can be brought about, and further sufficient pressing contact of the flanks can be secured when tightening, even if any unevenness is produced in pitch and angle of the screw thread portions. And, excellent stability can be also secured. Production yield thereof is high, and excellent productivity can be achieved.

(10) Since the length of the nut-annular groove portion in the axial direction is within a prescribed range, the buckling load of the nut-annular groove portion can be made adequate, and the phase of the sub female screw thread portion can be easily displaced within a prescribed range by compressing and deforming the nut-annular groove portion, wherein excellent productivity and excellent stability can be brought about.

(11) Since the reaction force that the sub female screw thread portion gives to the male screw thread can be set within a prescribed range by regulating the cross sectional area of the extending portion at the nut-annular groove portion, loosening-stop can be achieved without impairing a male screw thread and a female screw thread portion.

(12) Since the extending portion at the nut-annular groove portion is formed so as to have a prescribed thickness and the mechanical strength is set within a prescribed range, it is possible to easily displace the phase of the sub female screw thread portion within a prescribed range when compressing and deforming the extending portion. Also, since the extending portion at the nut-annular groove portion adequately elongates and the extending portion elongates when a male screw thread such as a bolt is screwed in, screw thread ridges of the male screw thread and sub female screw thread portion are scarcely crushed, and excellent mountability thereof can be brought about.

(13) Since the outer diameter of the extending portion is formed to be 30 through 100% of the outer diameter of an inscribed circle which internally touches the outer edge of a cross sectional surface orthogonal to the axial direction of the nut body, and the outer diameter of the extending portion is smaller than the nut body, the extending portion does not constitute any obstacle when tightening the nut body using a wrench and the like, and the wrench can be inserted into the nut body, wherein tightening can be facilitated, and excellent tightening operation can be carried out.

(14) Since the angle θ2 of the nut-resilient portion is formed within a prescribed range, optimal resiliency can be secured at the nut-resilient portion, and simultaneously a stable relationship between displacement and a reaction force of the nut-resilient portion is secured, wherein the reaction force thus obtained is almost free from unevenness, and excellent stability is secured.

Also, in Embodiment 3, a description was given of a case where the nut-annular portion 46 is displaced by only the γ amount of deformation (n is an integral number including or more than 0). However, by applying a tensile load to the nut-annular groove portion 46, they amount of deformation (where n is 0) may be in a range of −5/18·P′≦γ≦−1/30·P′, preferably −¼·P′≦γ≦−1/15·P′, further preferably −⅕·P′≦γ≦−1/15·P′. In this case, actions similar to the above can be obtained.

In addition, it is possible to deform by compression or tension while being twisted when the nut-annular groove portion 46 is deformed by the γ amount of deformation. Also, in this case, actions similar to the above can be obtained.

(Embodiment 6)

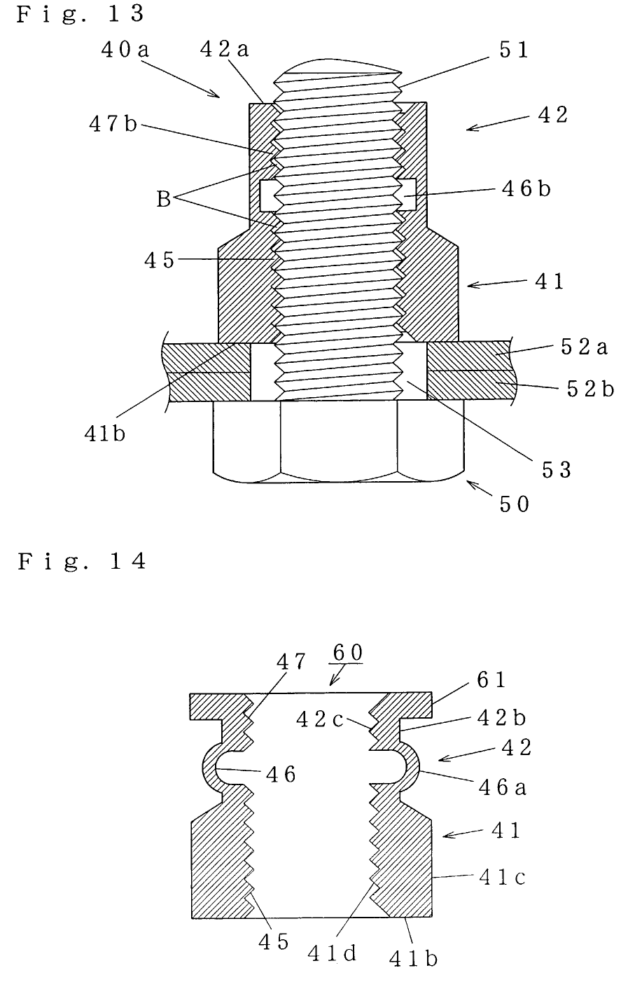

FIG. 13 is across sectional view of the major parts showing a state where a member to be tightened is tightened by a loosening-stop nut according to Embodiment 6. Also, a description is given of a relationship between stress and distortion, which are applied to the main female screw thread portion and sub female screw thread portion when a member to be tightened is tightened by a loosening-stop nut according to Embodiment 6, using FIG. 7 described above. In this case, the ordinate indicates stress applied to the main female screw thread portion and sub female screw thread portion, and the abscissa indicates an amount of distortion of the main female screw thread portion and sub female screw thread portion. Also, components of Embodiment 6, which are identical to those described in Embodiment 3 are given the same reference numbers, and a description thereof is omitted.

In the drawing, 40a denotes a loosening-stop nut according to Embodiment 6. A nut-annular groove portion 46b is formed annular in a direction roughly orthogonal to the axial direction of the extending portion 42 with a larger diameter than the root diameter of the main female screw thread portion 45 on the inner circumferential wall 42c at the nut body 41 side of the extending portion 42. A sub female screw thread portion 47b is formed by threading with a lathe, etc., with the same shape and pitch as those of the main female screw thread portion 45 on the inner circumferential wall 42c of the extending portion 42 from the nut-annular groove portion 46 toward the top face 42a of the extending portion 42, so that the phase thereof with respect to the main female screw thread portion 45 is displaced by 12 through 100°, preferably 24 through 90° or further preferably 24 through 72°.

Points in which the loosening-stop nut according to the Embodiment 6 differ from that according to Embodiment 3 are in that the phase of the sub female screw thread portion is not displaced by compressing and deforming the nut-annular groove portion 46b, but the phase of the sub female screw thread portion 47b with respect to the main female screw thread 45 is displaced by 12 through 100°, preferably 24 through 90° or further preferably 24 through 72° by threading using a lathe, etc., and the loosening-stop nut does not have a nut-resilient portion in which the nut-annular groove portion 46b is deformed.

Where the members 52a and 52b to be tightened are tightened by a bolt 50 and a loosening-stop nut 40a, as shown in FIG. 13, as has been described in Embodiment 3, if the bolt 50 is inserted into bolt holes 53 of the members 52a and 52b, and the loosening-stop nut 40a is screwed to the male screw thread 51 of the bolt 50, the bearing surface 41b of the loosening-stop nut 40a is brought into contact with the surface of the member 52a and the loosening-stop nut 40a is firmly tightened. As a result, stress (Point S in FIG. 7) that is larger than the resiliency limit (Point U in FIG. 7) but smaller than the extreme strength (Point M in FIG. 7) is produced at the main female screw thread portion 45 and sub female screw thread portion 47b by screw-in of the male screw thread 51, whereby the main female screw thread portion 45 is screwed in the male screw thread 51, and permanent distortion (0S₁in FIG. 7) is produced at the sub female screw thread portion 47b and deformed. Therefore, backlashes B and B due to unevenness in machining accuracy of the male screw thread 51 of the bolt 50, main female screw thread portion 45, and sub female screw thread portion 47b are produced in the normal and reverse directions at the main female screw thread portion 45 and the sub female screw thread portion 47b. Further, since the flanks of the sub female screw thread portion 47b and the main female screw portion 45 press the flank of the male screw thread 51 in the normal reverse directions by the reaction force produced by resilient deformation (S₁S₂ shown in FIG. 7), and these are firmly tightened.

Since the loosening-stop nut 40a, which is once screwed to the bolt 50, is deformed by permanent distortion (0S₁ shown in FIG. 7) produced at the sub female screw thread portion 47b in response to the male screw thread 51 of the bolt 50, the deformation is maintained after it is removed from the bolt 50. Even where the loosening-stop nut 40a is screwed to the bolt 50 again, a reaction force produced by resilient deformation (S₁S₂ shown in FIG. 7) of the sub female screw thread portion 47b works with the male screw thread 51 of the bolt 50, wherein these may be repeatedly tightened.

Since the loosening-stop nut according to Embodiment 6 is constructed as described above, the following actions can be brought about in addition to the actions described in Embodiment 1.

(1) Since the phase (phase with respect to a male screw thread to be screwed) of the sub female screw thread portion with the main female screw thread portion is displaced by threading using a lathe, etc., no press facility for compression deformation is required, wherein facility costs can be reduced.

In addition, at the loosening-stop nut in Embodiment 3, a reaction force that is produced by permanent distortion (0S₁ shown in FIG. 7) and resilient deformation (S₁S₂ shown in FIG. 7), which are described in Embodiment 6 is generated in addition to a reaction force (P) that is produced at the nut-resilient portion 46a, and the loosening-stop nut in Embodiment 3 can obtain a larger reaction force than that in Embodiment 6, wherein a larger screwing force can be obtained.

(Embodiment 7)

FIG. 14 is a cross sectional end face view of the major parts of a loosening-stop nut according to Embodiment 7 of the invention. Also, components of Embodiment 7, which are identical to those in Embodiment 3, are given the same reference numbers, and a description thereof is omitted.

In the drawing, 60 denotes a loosening-stop nut according to Embodiment 7. A collar portion 61 is formed so that its outer edge is caused to protrude on the peripheral portion of the outer-circumferential wall 42b of the extending portion 42 whose outer edge is formed to roughly circular or roughly polygonal, and its outer edge (outer diameter) is formed to be the same as and larger than the outer diameter of the nut-resilient portion 46a. Herein, in Embodiment 7, the outer diameter of the collar portion 61 is formed to roughly the same as the outer diameter of the nut body 41.

Since the loosening-stop nut according to Embodiment 7is constructed as described above, the following actions can be brought about in addition to those described in Embodiment 3.

(1) Since the nut-resilient portion is accommodated inside between the collar portion, which protrudes to the outer circumferential wall of the extending portion and is formed to be roughly the same as the outer diameter of the nut body and the inside of the nut body, it is possible to prevent a wrench, which is used to tighten a loosening-stop nut, from being brought into contact with the nut-resilient portion, and to prevent the nut-resilient portion from being deformed or impaired, wherein the nut-resilient portion can be protected to increase durability. Also, a wrench, etc, is prevented from being brought into contact with the collar portion, which is used to tighten the loosening-stop nut, wherein tightening work can be improved.

(Embodiment 8)

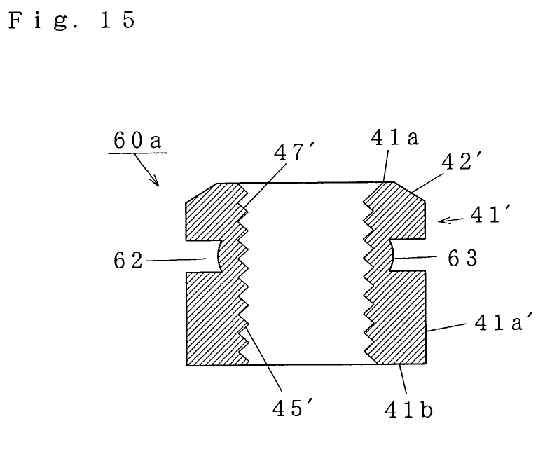

FIG. 15 is a cross sectional end face view of the major parts of a loosening-stop nut according to Embodiment 8 of the invention. Also, components of Embodiment 8, which are identical to those of Embodiment 3 or 4, are given the same reference numbers, and a description thereof is omitted.

In the drawing, 60a denotes a loosening-stop nut according to Embodiment 8. Points in which the loosening-stop nut according to Embodiment 8 are different from that of Embodiment 4 are in that an outer circumferential groove portion 62 having a width which is 1/30 or more of the pitch (P′) of the main female screw thread portion 45′ and sub female screw thread portion 47′ is formed on the outer circumferential wall of a nut 41′ that are standardized by JIS, ASME, etc., and the nut has a nut-resilient portion 63 in which the outer circumferential groove portion 62 is compressed in the axial direction by an γ amount of deformation of (n+1/30)P′≦γ≦(n+5/18)P′, preferably (n+1/15)P′≦γ≦(n+¼)P′, further preferably (n+1/15)P′≦γ≦(n+⅕)P′, or (n−5/18)P′≦γ≦(n−1/30)P′, preferably (n−¼)P′≦γ≦(n−1/15)P′, or further preferably (n−⅕)P′≦γ≦(n−1/15)P′, (however, n is an integral number more than 0, and γ is positive in the compressing direction and negative in the tensile direction).

With the differences, the loosening-stop nut according to Embodiment 8 has an outer circumferential groove portion formed on the outer circumferential wall of the standardized nut body. Therefore, it is possible to form a sub female screw thread portion whose phase with respect to the main female screw thread portion is displaced by 12 through 100°, preferably 24 through 90° or further preferably 24 through 72° by applying a load roughly in parallel to the axial direction.

(Embodiment 9)

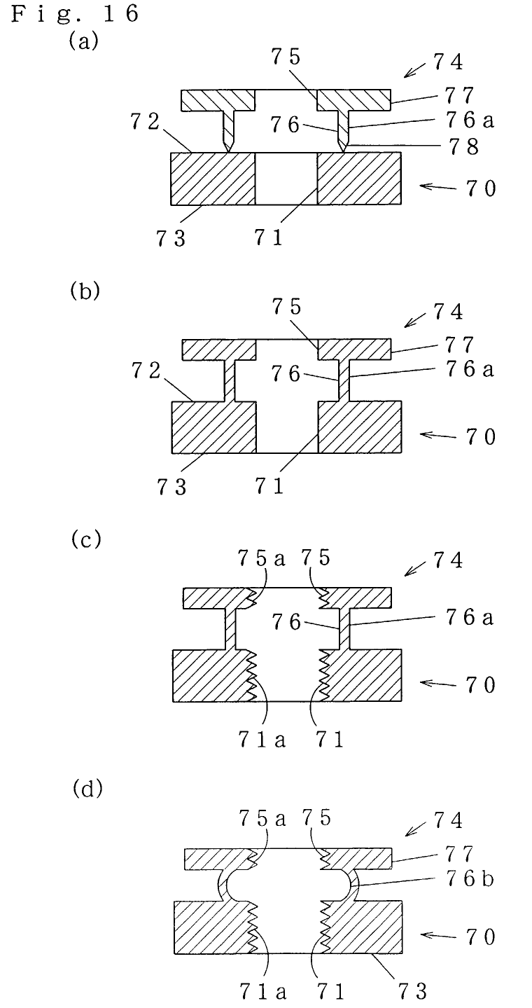

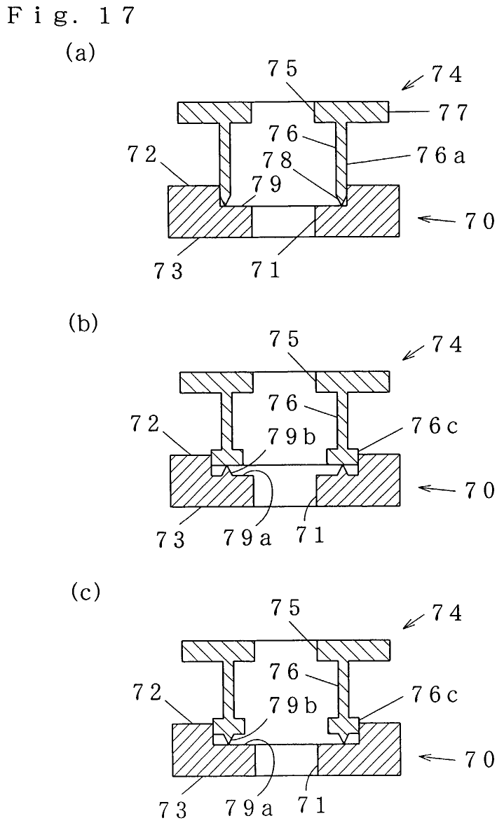

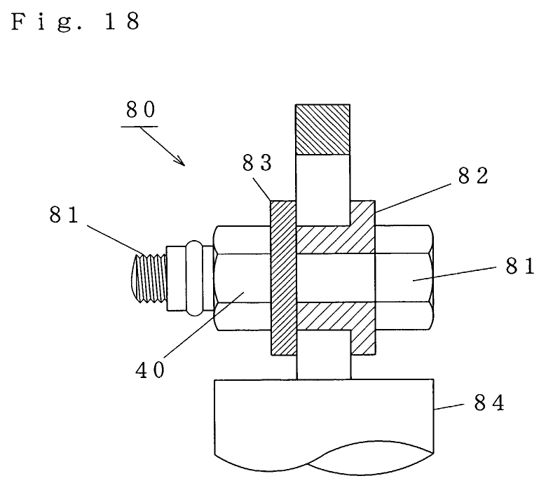

FIG. 16(a) is a sectional view of the major parts showing a step of forming an extending portion in a method for producing a loosening-stop nut according to Embodiment 9, FIG. 16(b) is a sectional view of the major parts showing a step of fixing the extending portion in a method for producing a loosening-stop nut according to Embodiment 9, FIG. 16(c) is a sectional view of the major parts showing a step of forming a female screw thread in a method for producing a loosening-stop nut according to Embodiment 9, and FIG. 16(d) is a sectional view of the major parts showing a step of forming a nut-resilient portion in a method for producing a loosening-stop nut according to Embodiment 9. FIG. 17 is a sectional view of the major parts showing an example of application with respect to the shape of the extending portion and nut body.

In FIG. 16(a) and FIG. 16(b), 70 denotes a cylinder nut body whose outer shape is formed to be hexagonal. 71 denotes the inner-circumferential wall of the nut body 70. 72 denotes the top face of the nut body 70. 73 denotes the bearing surface of the nut body 70. 74 denotes an extending portion which is formed separately from the nut body 70 and has a smaller collar portion (described later) than the diameter of the nut body 70. 75 denotes the inner-circumferential wall of the extending portion 74, which is formed with the same diameter as that of the inner-circumferential wall 71 of the nut body 70. 76 denotes a nut-annular groove portion which is formed to be annular in a direction roughly orthogonal to the axial direction of the extending portion 74 on the inner-circumferential wall 75 of the extending portion 74. 76a denotes the outer-circumferential wall of the extending portion 74. 77 denotes a collar portion protruding from the peripheral portion of the outer-circumferential wall 76a at one end portion of the extending portion 74. 78 denotes a projection portion that is formed to be like a plurality of protrusions, protruding lines, or annular top-open members.

In FIG. 16(c), 71a denotes a female screw thread formed on the inner-circumferential wall 71 of the nut body 70. 75a denotes a female screw thread formed on the inner-circumferential wall 75 of the extending portion 74. The female screw threads 71a and 75a are formed with the same pitch and phase.

In FIG. 16(d), 76b denotes a nut-resilient portion (the drawing shows a swelled state brought about by deformation by compression) swelled or recessed to the outer-circumferential wall 76a side of the extending portion 74 or compressed (or pulled) in the axial direction since, where it is assumed that the size of a pitch of the female screw threads 71a and 75a is P′, the extending portion 74 at the nut-resilient groove portion 76 is deformed by a length of a γ amount of deformation of the nut-annular groove portion or the outer circumferential groove portion in the axial direction being (n+1/30)P′≦γ≦(n+5/18)P′, preferably (n+1/15)P′≦γ≦(n+¼)P′, further preferably (n+1/15)P′≦γ≦(n+⅕)P′, or (n−5/18)P′≦γ≦(n−1/30)P′, preferably (n−¼)P′≦γ≦(n−1/15)P′, or further preferably (n−⅕)P′≦γ≦(n−1/15)P′, (however, n is an integral number more than 0, and γ is positive in the compressing direction and negative in the tensile direction).

In FIG. 17(a), a body recess 79 is formed on the top face 72 of the inner-circumferential wall 71 side of the nut body 70 coaxially with the nut body 70 and with an inner diameter, which is slightly larger than the outer diameter of the outer-circumferential wall 76a of the extending portion 74, and the body recess 79 can retain the extending portion 74 coaxially with the nut body 70 in a stabilized state by inserting the extending portion 74 in the body recess 79.

In FIG. 17(b), 76c denotes a thick portion formed to be thick at the other end portion of the extending portion 74. A body recess 79a is formed on the top face 72 at the inner-circumferential wall 71 side of the nut body 70 coaxially with the nut body 70 and with an inner diameter, which is slightly larger than the outer diameter of the thick portion 79c of the extending portion 74. 79b denotes a projection formed upwards on the bottom of the body recess 79a. Since welding is carried out between the thick portion 76 of the extending portion 74 and the projection 79c of the nut body 70, it is possible to prevent the thin extending portion 74 having the nut-annular groove portion 76 formed from being deformed due to heat of the welding, wherein product yield ratio can be increased. Also, as shown I FIG. 17(c), it is possible to form the projection 79b on the underside of the thick portion 76c without forming the projection 79b on the bottom of the body recess 79a. In this case, actions similar to the above can be brought about.

A description is given below of a method for producing a loosening-stop nut according to Embodiment 9, which is thus constructed, with reference to the accompanying drawings.

First, the step of forming a nut body forms a nut body 70 by a plasticizing process such as press molding and a cutting process. Also, in the step of forming an extending portion, the nut-annular groove portion 76 is formed on the inner-circumferential wall 75 by a plasticizing process such as press molding and a cutting process, and the extending portion 74 having a projection 78 formed at the tip end is formed. (See FIG. 16(a)).

Next, as shown in FIG. 16(a), in the step of fixing the extending portion, after the projection 78 of the extending portion 74 is brought into contact with the top face 72 of the nut body 70, the extending portion 74 is fixed on the top face 72 of the nut body 70 with an electric current flown between the extending portion 74 and the nut body 70 by resistance welding such as projection welding, which generates large resistance heat at the projection 78. (As for a state after being fixed, see FIG. 16(b)).

Next, in the step of forming a female screw thread, female screw threads 71a and 75a are formed with the same phase and pitch by cutting on the inner-circumferential wall 71 of the nut body 70 and on the inner-circumferential wall 75 of the extending portion 74. (See FIG. 16(c)).

Also, in the step of forming a nut-resilient portion, a larger load than the buckling load of the extending portion 74 at the nut-annular groove portion 76 is applied between the collar portion 77 of the extending portion 74 and the bearing surface 73 of the nut body 70 for a prescribed period of time, and a nut-resilient portion that is swelled to the outer-circumferential wall 76a side of the extending portion 74 is formed by being deformed by a γ amount of deformation by compression. (See FIG. 16(d)). Thereby, the female screw thread 71a is made into a main female screw thread portion, and the female screw thread 75a is made into a sub female screw thread portion whose phase with respect to the main female screw thread portion (female screw thread 71a) is displayed by 12 through 100°, preferably 24 through 90°, or further preferably 24 through 72°.

With the method for producing a loosening-stop nut according to Embodiment 9 that is thus constructed, the following actions can be brought about.

(1) Since the method is provided with a step of forming an extending portion, the nut body and extending portion are formed to be separate, and these are integrated in the step of fixing the extending portion, wherein excellent production efficiency can be secured.

(2) Since the extending portion is fixed at the nut body by resistance welding such as projection welding in the step of fixing the extending portion, it is possible to concentrate generation of resistance heat at the projection, wherein the projection is collapsed due to thermal softening to cause the contacting area to be increased, and an electric current is dispersed. Therefore, no overheat is brought about, wherein excellent safety is secured. In addition, since the nut body and extending portion are not largely melted, the mechanical strength is not lowered, and almost no decoloring is brought about. Further, it is possible to easily weld metals whose thickness remarkably differs like the thin extending portion and ore-like nut body.

(3) Since a nut-resilient portion is formed by applying a load between the collar portion formed at one end of the extending portion and the bearing surface of the nut body in the step of forming a nut-resilient portion, the load can be dispersed on the thin extending portion on which the nut-annular groove portion is formed, and uniform deformation by compression or tension is enabled, wherein production yield ratio can be increased.

### EXAMPLES

Hereinafter, a detailed description is given of the invention on the basis of examples. Further, the invention is not limited to the following examples.

### Example 1

Using a loosening-stop nut according to Embodiment 3, a loosening-stop nut of Example 1 was produced, in which the pitches (P′) of the main female screw thread portion and sub female screw thread portion are 2 mm, the root diameter of the main female screw thread portion and sub female screw thread portion is 16 mm, and the amount of deformation (deformation amount γ) of the nut-resilient portion in the axial direction is 1.47 mm.

### Example 2

Using a loosening-stop nut according to Embodiment 3, a loosening-stop nut of Example 2 was produced as in Example 1, except that the deformation amount γ is 1.57 mm.

### Example 3

Using a loosening-stop nut according to Embodiment 3, a loosening-stop nut of Example 3 was produced as in Example 1, except that the deformation amount γ is 1.65 mm.

### Example 4

Using a loosening-stop nut according to Embodiment 3, a loosening-stop nut of Example 4 was produced as in Example 1, except that the deformation amount γ is 1.90 mm.

### Example 5

Using a loosening-stop nut according to Embodiment 3, a loosening-stop nut of Example 5 was produced as in Example 1, except that the deformation amount γ is 2.10 mm.

### Example 6

Using a loosening-stop nut according to Embodiment 3, a loosening-stop nut of Example 6 was produced as in Example 1, except that the deformation amount γ is 2.30 mm.

### Example 7

Using a loosening-stop nut according to Embodiment 3, a loosening-stop nut of Example 7 was produced as in Example 1, except that the deformation amount γ is 2.43 mm.

### Example 8

Using a loosening-stop nut according to Embodiment 3, a loosening-stop nut of Example 8 was produced as in Example 1, except that the deformation amount γ is 2.53 mm.

### Comparison Example 1

Using a loosening-stop nut according to Embodiment 3, a loosening-stop nut of Comparison Example 1 was produced as in Example 1, except that the deformation amount γ is 1.97 mm.

### Comparison Example 2

Using two nuts having a female screw thread pitch of 2 mm and a root diameter of 16 mm at the female screw thread, a double (W) nut that is generally used as loosening-stop means was formed. This is used as a loosening-stop nut of Comparison Example 2.

(Proof Load Test)

A proof load test of loosening-stop nuts of Examples 1 through 8 was carried out by a tension test in the axial direction and a compression test in the axial direction in compliance with JIS B1502 (Mechanical characteristics of steel nuts). In the test, a test mandrel is screwed in the main female screw thread portion of a loosening-stop nut so that a proof load operates in the axial direction of the main female screw thread portion of the loosening-stop nut, and the proof load value was applied for 15 seconds.

With the test, there was no case where the screw thread ridges of the loosening-stop nut are damaged by shearing, and the nut is crushed. Also, after the applied proof load value was removed, the loosening-stop nut removed from the test mandrel could be inserted into and turned by finger for other bolts whose dimensions are the same as those of the test mandrel.

According to the results of the above-described proof load test, it was made clear that the loosening-stop nut according to the invention has a proof load free from any problem in practical use.

(Vibration Test)

A vibration test was carried out by using a NAS type high-speed loosening testing machine (in compliance with National Aircraft Standards NAS 3350) for loosening-stop nuts of Examples 1 through 8 and Comparison Examples 1 and 2.

FIG. 18 is a view showing the conditions of the vibration test.

In the drawing, 40 denotes loosening-stop nuts for the examples and comparison controls, which are mounted as test samples. 80 denotes a vibration testing machine, 81 denotes a bolt to which a loosening-stop nut 40 is screwed, 82 denotes a vibration barrel to which a bolt 81 and a loosening-stop nut 40 are attached. 83 denotes a washer mounted between a vibration barrel 82 and the loosening-stop nut 40. A vibration applicator base 84 repeatedly applies vibrations orthogonal to the axial direction of the bolt 81 to the loosening-stop nut 40 and bolt 81, which are fixed on the vibration barrel 82. In addition, the number of vibrations is 1780 rpm, the stroke of the vibration applicator base is 11 mm, and impact stroke is 19 mm.

After loosening-stop nuts according to Examples 1 through 8 and Comparison Examples 1 and 2 are mounted on the vibration testing machine with a tightening torque of 150 N·m, vibrations are applied thereto for 17 minutes (30,000 times). At this time, it is investigated whether or not any loosening occurs at the loosening-stop nuts 1. Also, where any identification mark attached to the washer 83, loosening-stop nut 40 and bolt 81 slips, it is judged that the loosening-stop nut 40 is loosened.

As a result, there is no nut in the loosening-stop nuts of Examples 1 through 8, in which loosening occurred. Also, the returning torque after the test is 130 N through 180 N·m, which is almost equivalent to the tightening torque. In addition, the loosening-stop nut of Comparison Example 1 dropped from the bolt when vibrations occurred 1500 times, and the loosening-stop nut (W nut) of Comparison Example 2 dropped from the bolt 4300 times. Further, a similar vibration test was carried out for another Comparison Example, which is a general nut provided with a spring washer. The nut having a spring washer dropped from a bolt 1350 times.

Next, after the loosening-stop nuts of Examples 3 and 6 are mounted to a vibration testing machine with a tightening torque of 150 N·m, vibrations of 1000000 times are given to the nuts, and it is investigated whether or not any loosening occurs in the loosening-stop nuts.

As a result, although the returning torque after the test became 200 N·m, which is slightly higher than the tightening torque, there is no case where the loosening-stop nuts are loosened through the test.

Based on the results of the above-described test, it is made clear that a loosening-stop nut according to the invention can be securely prevented from being loosened from a male screw thread and a high tightening force can be semi-permanently maintained.

In addition, since a loosening-stop bolt according to the invention is constructed on the basis of almost the same principle as the loosening-stop nut according to the invention, the bolt can be securely prevented from being loosened from a nut, wherein it is made clear that a high tightening force can be semi-permanently maintained.

As described above, with a structure for loosening-stop tightening means, a loosening-stop bolt having the structure, a method for producing the same bolt, and a loosening-stop nut having the structure, and a method for producing the same nut according to the invention, the following advantageous effects can be brought about.

Therefore, as described above, with a structure for loosening-stop tightening means, a loosening-stop bolt having the structure, a method for producing the same bolt, and a loosening-stop nut having the structure, and a method for producing the same nut according to the invention, the following advantageous effects can be brought about.

According to the first aspect of the invention;

(1) The following loosening-stop tightening means can be brought about. That is, since a loosening-stop tightening means which is screwed in a screw thread is such that the phase of the sub screw thread portion with respect to the main screw thread portion is displaced by a prescribed amount, the direction along which the flank of the main screw thread portion is brought into contact with the flank of a screw thread due to contact pressure produced by the tightening force differs by 180° from the direction along which the flank of the sub screw thread portion is brought into contact with the flank of a screw thread. That is, the directions run counter to each other by 180°. Therefore, the direction of a torque produced by the contact pressure and lead angle of the screw thread at the main screw thread portion differs in terms of plus and minus from the direction thereof at the sub screw thread portion, wherein if an external force such as vibrations is applied to a screw thread and a member to be tightened, and a force operating along the turning direction along which the main screw thread portion is likely to be loosened from the screw thread is added, a torque produced at the flank of the sub screw thread portion operates in the tightening direction. Accordingly, it is possible to securely prevent the loosening-stop tightening means from being loosened from the screw threads, and a high tightening force can be semi-permanently maintained.

According to the second aspect of the invention;

(1) The following loosening-stop bolt can be brought about. That is, since a loosening-stop bolt which is screwed in a female screw thread is such that the phase of the sub male screw thread portion with respect to the main male screw thread portion is displaced by a prescribed amount, the direction along which the flank of the main male screw thread portion is brought into contact with the flank of a female screw thread due to contact pressure generated by the tightening force differs by 180° from the direction along which the flank of the sub male screw thread portion is brought into contact with the flank of a female screw thread. That is, the directions run counter to each other. Therefore, the direction of a torque produced by the contact pressure and lead angle of the screw thread at the main male screw thread portion differs in terms of plus and minus from the direction thereof at the sub male screw thread portion, wherein if an external force such as vibrations is applied to a nut and a member to be tightened, and a force operating along the turning direction along which the main male screw thread portion is likely to be loosened from the female screw thread is added, a torque produced at the flank of the sub male screw thread portion operates in the tightening direction. Accordingly, it is possible to securely prevent the loosening-stop bolt from being loosened from the female screw threads, and a high tightening force can be semi-permanently maintained.

(2) The following loosening-stop bolt can be brought about. That is, since a sub male screw thread portion is provided on the outer circumference of the tip end portion of the bolt, which is formed so that the phase thereof with respect to the main male screw thread portion is displaced by 12 through 100°, preferably 24 through 90° or further preferably 24 through 72°, a reaction force with which the sub male screw thread portion presses the female screw thread in the direction of the main male screw thread portion, and a reaction force with which the main male screw thread portion presses the female screw thread in the direction of the sub male screw thread portion, or a reaction force with which the sub male screw thread portion presses the female screw thread in the direction opposite to the main male screw thread portion, and a reaction force (with which the main male screw thread portion presses the female screw thread in the direction opposite to the sub male screw thread portion are produced by screwing a loosening-stop bolt in the female screw thread when tightening a member to be tightened, whereby a large friction force can be obtained between the main male screw thread portion or the sub male screw thread portion and the female screw thread, it is possible to securely prevent the screwing force from being lowered due to a loosening of the main male screw thread portion, etc., from the female screw thread due to vibrations.

(3) The following loosening-stop bolt can be brought about. That is, if a tightening force is added by screwing the loosening-stop bolt in a female screw thread, the sub male screw thread portion of the loosening-stop bolt is deformed by the female screw thread to cause resilient deformation, wherein the main male screw thread portion and sub male screw thread portion can be more firmly adhered and tightened to the female screw thread by the reaction force in resilient deformation. Herein, the screwing force of the loosening-stop bolt and female screw thread can be further increased, and it is possible to further securely prevent the loosening-stop bolt from being loosened from the female screw thread due to an external force such as vibrations.

(4) The following loosening-stop bolt can be brought about. That is, even in a case where any loosening is produced by wearing between a member to be tightened and the bearing surface, it is possible to prevent the loosening-stop bolt from slipping off the female screw thread by a reaction force by which the sub male screw thread portion presses the female screw thread in the direction of the main male screw thread portion or a reaction force by which the sub screw thread portion presses the female screw thread in the direction opposite to the main male screw thread portion, wherein, if the loosening-stop bolt is applied to vehicles or bridges where vibrations are remarkable, it is possible to prevent a falling accident by which bolts and nuts slip out therefrom and drop.

(5) The following loosening-stop bolt can be brought about. That is, since the main male screw thread portion and sub male screw thread portion are firmly adhered to the female screw thread by a reaction force resulting from resilient deformation which is produced by the sub male screw thread portion of the loosening-stop bolt screwed in the female screw thread being deformed by the female screw thread, play due to unevenness in machining accuracy of the female screw thread and the male screw thread portion of the loosening-stop bolt can be absorbed in resilient deformation, stability thereof is excellent, and at the same time, since the amount of displacement is small, the screw thread portions of the loosening-stop bolt and nut are hardly impaired when being tightened, wherein since the reaction force can be obtained in a stabilized state by resilient deformation, if the female screw thread is the same one, it can be re-screwed after the loosening-stop bolt is once removed and can be repeatedly used. That is, the bolt is excellent in repeated use.

(6) The following loosening-stop bolt can be brought about. That is, since the loosening-stop bolt has a bolt-annular groove portion formed with the same depth as the root of the main male screw thread portion or deeper than the root thereof, the main male screw thread portion can be smoothly screwed into the female screw thread when being screwed, and at the same time, deformation by compression or tension can be facilitated, wherein the degree of freedom in design can be increased, and it is possible to prevent the main male screw thread portion, etc., from being buckled in deformation by compression.

According to the third aspect of the invention, in addition to the effects described in the second aspect;

(1) The following loosening-stop bolt can be brought about. That is, the shank of the bolt-annular groove portion is made thin by the tip end recessed portion, wherein mechanical strength such as resilience and bending stress can be optimized, wherein a reaction force responsive to a screw thread portion can be obtained. Further, it is possible to prevent the screw thread portion from being damaged and for the same screw thread portion to be hardly loosened.

According to the fourth aspect of the invention, in addition to the effects described in the third aspect;

(1) The following loosening-stop bolt can be brought about. That is, since the bolt tip end portion at the bolt-annular groove portion is provided with a bolt-resilient portion deformed by compression or tension, and the bolt-resilient portion has resiliency, the bolt-resilient portion can absorb play resulting from unevenness in machining accuracy of a female screw thread and a male screw thread portion of the loosening-stop bolt by elongation or contraction of the bolt-resilient portion, which is produced by the screwed female screw thread in addition to resilient deformation of the sub male screw thread portion, which is produced according to the screwed female screw thread, and can further increase the reaction force, which is produced according to resiliency of the bolt-resilient portion, wherein it is possible to further reliably prevent the loosening-stop bolt from being loosened from the female screw thread.

(2) The following loosening-stop bolt can be brought about. That is, since the bolt-annular groove portion can be deformed by compression and tension after the main male screw thread portion and sub male screw thread portion are formed with the same pitch and the same phase, it is possible to easily shift the phases of the main male screw thread portion and sub male screw thread portion, and production thereof can be facilitated, wherein productivity is excellent.

According to the fifth aspect of the invention, in addition to the effects described in the fourth aspect;

(1) The following loosening-stop bolt can be brought about. That is, by deforming the bolt-annular groove portion using the α amount of deformation, it is possible to securely displace the phase of the sub male screw thread portion with respect to the main male screw thread portion by 12 through 100°, preferably 24 through 90° or further preferably 24 through 72°, wherein product yields are high, and productivity thereof is excellent.

(2) The following loosening-stop bolt can be brought about. That is, since the bolt-annular groove portion can be set to a prescribed amount of deformation by varying the figure “n”, and the resiliency of the bolt-resilient portion can be varied as long as the deformation of the bolt-annular groove portion is within the resiliency limit, the relationship between the displacement of the bolt-resilient portion and the reaction force thereof can be stabilized, and unevenness of the reaction force obtained is slight, wherein stability is excellent.

According to the sixth aspect of the invention, in addition to the effects described in any one of the second aspect through the fifth aspect;

(1) The following loosening-stop bolt can be brought about. That is, since the reaction force Q that the sub male screw thread portion gives to the female screw thread can be set in a prescribed range by regulating the cross sectional area of the shank of the bolt-annular groove portion, it is possible to suppress a free torque Tq before tightening, to 1 through 50 N·m or so, wherein the tightening efficiency is excellent.

(2) The following loosening-stop bolt can be brought about. That is, since the thickness of the shank of the bolt-annular groove portion is formed to be a prescribed thickness and the mechanical strength is set to a prescribed range, the phase of the sub male screw thread portion can be easily displaced in a prescribed range by deforming the bolt tip end portion. Also, an adequate length of elongation is liable to be produced at the shank of the bolt-annular groove portion, wherein the shank is elongated when being screwed in the female screw thread, and thread ridges of the female screw thread and sub male screw thread portion are hardly impaired. Excellent mounting can be secured.

According to the seventh aspect of the invention;

(1) The following method for producing a loosening-stop bolt can be brought about. That is, by deforming the bolt shank at the bolt-annular groove portion on which the tip end recessed portion is formed, the main male screw thread portion and sub male screw thread portion whose phase shifts can be easily formed. Therefore, production thereof is easy and productivity thereof is excellent.

(2) The following method for producing a loosening-stop bolt can be brought about. That is, since the bolt shank at the bolt-annular groove portion is deformed by the α amount of deformation, the phase of the sub female screw thread portion with respect to the main female screw thread portion may be displaced by 12 through 100°, preferably 24 through 90° or further preferably 24 through 72°, reliability thereof and work efficiency thereof are excellent.

According to the eighth aspect of the invention;

(1) The following loosening-stop nut can be brought about. That is, since the phase of the sub female screw thread portion with respect to the main female screw thread portion is displaced by a prescribed amount in the loosening-stop nut tightened by a male screw thread, the direction along which the flank of the main female screw thread portion is brought into contact with the flank of a male screw thread due to contact pressure produced by the tightening force differs by 180° from the direction along which the flank of the sub female screw thread portion is brought into contact with the flank of a male screw thread. That is, the directions run counter to each other. Therefore, the direction of a torque produced by the contact pressure and lead angle of the screw thread at the main female screw thread portion differ in terms of plus and minus from the direction of a torque thereof at the sub female screw thread portion, wherein, if an external force such as vibrations is applied to a bolt and a member to be tightened, and a force operating along the turning direction along which the main female screw thread portion is likely to be loosened from the male screw thread is added, a torque produced at the flank of the sub female screw thread portion operates in the tightening direction. Accordingly, it is possible to securely prevent the loosening-stop nut from being loosened from the male screw threads, and a high tightening force can be semi-permanently maintained.

(2) The following loosening-stop nut can be brought about. That is, a sub female screw thread portion formed so that the phase thereof with respect to the main female screw thread portion is displaced by 12 through 100°, preferably 24 through 90° or further preferably 24 through 72° is provided on the inner circumferential wall of an extension portion extending on the nut body. Therefore, a reaction force with which the sub female screw thread portion presses the male screw thread in the direction of the main female screw thread portion, and a reaction force with which the main male screw thread portion presses the male screw thread in the direction of the sub female screw thread portion, or a reaction force with which the sub female screw thread portion presses the male screw thread in the direction opposite to the main female screw thread portion, and a reaction force with which the main female screw thread portion presses the male screw thread in the direction opposite to the sub female screw thread portion are produced by screwing a loosening-stop nut in the male screw thread of a bolt when tightening a member to be tightened, whereby a large friction force can be obtained between the main female screw thread portion or the sub female screw thread portion and the male screw thread, it is possible to securely prevent the screwing force from being lowered due to a loosening of the main female screw thread portion, etc., from the male screw thread due to vibrations.

(3) The following loosening-stop nut can be brought about. That is, where a loosening-stop nut is tightened to a male screw thread of a bolt, and a tightening force is applied thereto, the sub female screw thread portion of the loosening-stop nut is resiliently deformed by a male screw thread of a bolt, these can be tightened so that the main female screw thread portion and sub female screw thread portion are further tightly adhered to the male screw thread by the reaction force. Therefore, the screwing force of the loosening-stop nut with a male screw thread of a bolt is increased, and it is possible to further securely prevent the loosening-stop nut from being loosened from the male screw thread of a bolt by an external force such as vibrations.

(4) The following loosening-stop nut can be brought about. That is, even where wearing occurs between a member to be tightened and the bearing surface, and looseness is produced there, the loosening-stop nut can be prevented from slipping of f a bolt, etc., by a reaction force by which the sub female screw thread portion presses the male screw thread in the direction of the main female screw thread portion or a reaction force by which the sub female screw thread portion presses the male screw thread in the direction opposed to the main female screw thread portion, wherein it is possible to prevent a loosening-stop nut from falling down from a bolt or the like, and it is possible to prevent a nut and/or a bolt from falling from vehicles and bridges where vibrations of vehicles and tramcars are remarkable.

(5) The following loosening-stop nut can be brought about. That is, since the main female screw thread portion and sub female screw thread portion are tightly adhered to a male screw thread by a reaction force resulting from resilient deformation produced by the sub female screw thread portion of a loosening-stop nut, which is screwed with a male screw thread of a bolt, being deformed by the male screw thread, it is possible to absorb play due to unevenness in machining accuracy of a male screw thread of a bolt and a female screw thread portion of a loosening-stop nut, wherein excellent stability can be secured. Also, since the amount of displacement in the phase is slight, the loosening-stop nut and screw thread portion of a bolt are scarcely impaired when tightening, wherein a stable reaction force can be obtained. Therefore, if the male screw thread is the same one, it can be re-screwed after the loosening-stop nut is once removed and can be repeatedly used. That is, the bolt is excellent in repeated use.

(6) The following loosening-stop nut can be brought about. That is, since the loosening-stop nut has a nut-annular groove portion formed with the same diameter as the root diameter of the main female screw thread portion or with a larger outer diameter than the root diameter, the sub female screw thread portion can be smoothly screwed with a male screw thread of a bolt, and deformation can be facilitated, wherein the degree of freedom in design can be secured, and buckling can be prevented from occurring.

According to the ninth aspect of the invention, in addition to the effects described in the eighth aspect;

(1) The following loosening-stop nut can be brought about. That is, if an outer circumferential groove portion is formed on the outer circumferential wall of a nut body formed of a nut which is standardized by JIS, ASME, DIN, etc., it is possible to form a sub female screw thread portion whose phase with respect to the main female screw thread portion is displaced by 12 through 100° by only applying a load roughly in parallel to the axial direction, wherein excellent universal use can be obtained.

According to the tenth aspect of the invention, in addition to the effects described in the eighth aspect;

(1) The following loosening-stop nut can be brought about. That is, since elongation and deformation can be facilitated by making thin the extending portion at the nut-annular groove portion or the nut body, wherein the flanks of the main female screw thread portion and sub female screw thread portion press the flank of the male screw thread without crushing and impairing the male screw thread of a bolt, etc., and thread ridges of the sub female screw thread, a screwing force can be obtained.

According to the eleventh aspect of the invention, in addition to the effects described in any one of the eighth aspect through the tenth aspect;

(1) The following loosening-stop nut can be brought about. That is, since the nut-resilient portion in which the extending portion at the nut-annular groove portion is deformed by compression or tension has resiliency, play due to unevenness in machining accuracy of the male screw thread and female screw thread portion of the loosening-stop nut can be absorbed by elongation or contraction of the nut-resilient portion, which is brought about by a male screw thread of a bolt screwed, in addition to resilient deformation of the sub female screw thread portion, which is produced by the male screw thread of the bolt screwed, and at the same time, a reaction force that is produced can be further increased by stress generated in response to the resiliency which the nut-resilient portion has, wherein it is possible to further securely prevent the loosening-stop nut from being loosened from the male screw thread of a bolt, etc.,

(2) The following loosening-stop nut can be brought about. That is, since the nut-annular groove portion is deformed by compression or tension after the main female screw thread portion and sub female screw thread portion are formed with the same pitch and phase, it is possible to easily shift the phase of the main female screw thread portion and sub female screw thread portion. Therefore, production thereof is easy, and excellent productivity can be brought about.

According to the twelfth aspect of the invention, in addition to the effects described in the tenth aspect of the eleventh aspect;

(1) The following loosening-stop nut can be brought about. That is, since, by forming the amount of deformation of the nut-annular groove portion and outer circumferential groove portion with a prescribed range, it is possible to displace the phase of the sub female screw thread portion with respect to the main female screw thread portion screwed by 12 through 100°, preferably 24 through 90°, or further preferably 24 through 72°, production yield thereof is high, and productivity thereof is high.

According to the thirteenth aspect of the invention, in addition to the effects described in any one of the eighth aspect through the twelfth aspect;

(1) The following loosening-stop nut can be brought about. That is, since the reaction force Q which the sub female screw thread portion gives to the male screw thread can be set to a prescribed range by regulating the cross sectional area of the extending portion at the nut-annular groove portion, it is possible to suppress a free torque Tq, to approx. 1 through 50 N·m and the like, wherein the tightening efficiency is excellent.

(2) The following loosening-stop nut can be brought about. That is, since the mechanical strength is secured within a prescribed range by forming the thickness of the extending portion at the nut-annular groove portion to a prescribed thickness, it is possible to displace the phase of the sub female screw thread portion within a prescribed range by deforming the extending portion. Also, adequate elongation is apt to occur at the extending portion at the nut-annular groove portion, wherein the extending portion, etc., is adequately elongated when a male screw thread of a bolt is screwed, and the screw thread ridges of the male screw thread and sub female screw thread portion are scarcely impaired. Therefore, excellent mountability can be secured.

According to the fourteenth aspect of the invention, in addition to the effects described in any one of the eleventh aspect through the thirteenth aspect;

(1) The following loosening-stop nut can be brought about. That is, since the nut-resilient portion swelled out by deformation by compression is accommodated between the collar portion protruded to the outer circumferential wall of the extending portion and the inside of the nut body, it is possible to prevent a wrench, etc., which is used to tighten a loosening-stop nut, from being brought into contact with the nut-resilient portion, and to prevent the nut-resilient portion from being deformed or impaired, wherein the nut-resilient portion can be protected to increase durability.

According to the fifteenth aspect of the invention, in addition to the effects described in any one of the eighth aspect through the fourteenth aspect;

(1) The following loosening-stop nut can be brought about. That is, since it is not necessary to form a welding leg when the extending portion is fixed on the top face of a nut body by welding, welding is facilitated, and excellent work efficiency can be obtained.

(2) The following loosening-stop nut can be brought about. That is, since the outer diameter of the extending portion is formed to be 30 through 100% of the outer diameter of an inscribed circle that internally touches the outer edge of the cross sectional surface orthogonal to the axial direction of the nut body, and the outer diameter of the extending portion is smaller than the nut body, no extending portion becomes an obstacle when tightening the nut body by using a wrench, etc., and the wrench can be easily inserted into the nut body. Accordingly, tightening work efficiency is excellent.

According to the sixteenth aspect of the invention;

(1) The following method for producing a loosening-stop nut can be brought about. That is, by deforming the nut-annular groove portion after a female screw thread is formed on the inner-circumferential wall, it is possible to easily form a main female screw thread portion and a sub female screw thread portion, the phases of which slip, wherein production can be facilitated, and productivity is excellent.

(2) The following method for producing a loosening-stop nut can be brought about. That is, since, by forming the amount of deformation of the nut-annular groove portion with a prescribed range, it is possible to displace the phase of the sub female screw thread portion with respect to the main female screw thread portion by 12 through 100°, preferably 24 through 90°, or further preferably 24 through 72°, excellent reliability and excellent work efficiency can be brought about.

According to the seventeenth aspect of the invention;

(1) The following method for producing a loosening-stop nut can be brought about. That is, since the method includes a step of forming, by screwing a sub screw thread portion with a lathe, a screw thread groove portion in which the phase of the sub female screw thread portion with respect to the main female screw thread portion is displaced, no press facility used for compression deformation is required, wherein the facility cost can be suppressed.

According to the eighteenth aspect of the invention, in addition to the effects described in the sixteenth aspect;

(1) The following method for producing a loosening-stop nut can be brought about. That is, since the method includes a step of forming an extending portion, the extending portion and nut-annular groove portion can be freely designed, wherein the degree of freedom in design can be increased.

According to the nineteenth aspect of the invention, the effects described in the seventeenth aspect and the eighteenth aspect can be also brought about.

According to the twentieth aspect of the invention;

(1) The following method for producing a loosening-stop nut can be brought about. That is, since the method is provided with the step of forming an extending portion, it is possible to freely form the profiles of the extending portion and nut-annular groove portion, and at the same time, the nut-resilient portion can be molded. Therefore, it is possible to provide a method for producing a loosening-stop nut, which has a high degree of freedom.

What is claimed is:

1. A structure of a loosening-stop tightening means for a loosening-stop bolt and a loosening-stop nut, which is screwed in a screw thread and tightens a member to be tightened; comprising:
tightening means; a main screw thread portion formed on said tightening means; and a sub screw thread portion, formed coaxially with said main screw thread portion, whose phase with respect to said main screw thread portion is displaced by 12 through 100°, preferably 24 through 90° or further preferably 24 through 72°.

2. A loosening-stop bolt having a structure of a loosening-stop tightening means as set forth in claim 1, which is screwed in a female screw thread and tightens a member to be tightened; comprising: a bolt tip end portion formed coaxially with a bolt axis portion at the tip end portion of said bolt axis portion; a main male screw thread portion formed on the outer circumference of said bolt axis portion; a bolt-annular groove portion formed at the same depth as the root of said main male screw thread portion or formed to be annular deeper than said root on the outer circumference of said bolt axis portion side at said bolt tip end portion; and a sub male screw thread portion, formed on the outer circumference of said bolt tip end portion, whose phase with respect to said main male screw thread portion is displaced by 12 through 100°, preferably 24 through 90° or further preferably 24 through 72°.

3. The loosening-stop bolt as set forth in claim 2, wherein said bolt tip end portion is provided with a tip end recessed portion from the tip end of said bolt tip end portion to at least said bolt-annular groove portion centering around the axis center of said bolt tip end portion.

4. The loosening-stop bolt as set forth in claim 3, wherein said bolt tip end portion at said bolt-annular groove portion is provided with a bolt-resilient portion deformed by compression or tension in the axial direction.

5. The loosening-stop bolt as set forth in claim 4, wherein, where it is assumed that the size of a pitch of said main male screw thread portion is P, an α amount of deformation of said bolt-annular groove portion in the axial direction is (n+1/30)P≦α≦(n+5/18)P, preferably (n+1/15)P≦α≦(n+¼)P, further preferably (n+1/15)P≦α≦(n+⅕)P, or (n−5/18)P≦α≦(n−1/30)P, preferably (n−¼)P≦α≦(n−1/15)P, or further preferably (n−⅕)P≦α≦(n−1/15)P, (however, n is an integral number more than 0, and α is positive in the compressing direction and negative in the tensile direction).

6. The loosening-stop bolt as set forth in any one of claims 2 through 5, wherein the cross sectional area of the shank of said bolt-annular groove portion is 5 through 50% of the cross sectional area at the root diameter of said bolt shank.

7. A method for producing a loosening-stop bolt having the structure of the loosening-stop tightening means according to claim 1, which is screwed in a female screw thread and tightens a member to be tightened; comprising the steps of: forming a tip end recessed portion by drilling the bolt shank at its center from the tip end thereof; forming a bolt-annular groove portion at the same depth as that of a root of a male screw thread or deeper than the depth of the root on the outer circumference of a prescribed part at the tip end side of said bolt shank; applying prescribed load roughly in parallel to said bolt shank for a prescribed period of time, and forming a bolt-resilient portion by deforming said bolt shank at said bolt-annular groove portion formed by the step of forming said bolt-annular groove portion so that, where it is assumed that the size of a pitch of said male screw thread is P, the α amount of deformation becomes (n+1/30)P≦α≦(n+5/18)P, preferably (n+1/15)P≦α≦(n+¼)P, further preferably (n+1/15)P≦α≦(n+⅕)P, or (n−5/18)P≦α≦(n−1/30)P, preferably (n−¼)P≦α≦(n−1/15)P, or further preferably (n−⅕)P≦α≦(n−1/15)P, (however, n is an integral number more than 0, and α is positive in the compressing direction and negative in the tensile direction).

8. A loosening-stop nut having a structure of a loosening-stop tightening means as set forth in claim 1, which is screwed in a male screw thread of a bolt and tightens a member to be tightened, comprising: a nut body, an extending portion extending coaxially with said nut body; a main female screw thread portion formed on the inner circumferential wall of said nut body; a nut-annular groove portion formed to be equal to the root diameter of said main female screw thread portion or to be larger than the root diameter thereof on the inner circumferential wall at said nut body side of said extending portion or on the inner circumferential wall of said nut body; and a sub female screw thread portion, formed on the inner circumferential wall of said extending portion, whose phase with respect to said main female screw thread portion is displaced by 12 through 100°, preferably 24 through 90° or further preferably 24 through 72°.

9. The loosening-stop nut having a structure of a loosening-stop tightening means as set forth in claim 1, which is screwed in a male screw thread of a bolt and tightens a member to be tightened, comprising: a nut body, an extending portion extending coaxially with said nut body; a main female screw thread portion formed on the inner circumferential wall of said nut body; an outer circumferential groove portion formed in a direction orthogonal with the axial direction of said nut body on the outer circumferential wall at said nut body side of said extending portion or on the outer circumferential wall of said nut body; and a sub female screw thread portion, formed on the inner circumferential wall of said extending portion, whose phase with respect to said main female screw thread portion is displaced by 12 through 100°, preferably 24 through 90° or further preferably 24 through 72°.

10. The loosening-stop nut as set forth in claim 8, comprising an outer circumferential groove portion formed on said extending portion or on the outer circumferential wall of said nut-annular groove portion of said nut body.

11. The loosening-stop nut as set forth in any one of claims 8 through 10, wherein said nut-annular groove portion, said extending portion at said outer circumferential groove portion or said nut body is provided with a nut-resilient portion deformed by compression or tension in the axial direction.

12. The loosening-stop nut as set forth in claim 10 or 11, wherein, where it is assumed that the size of a pitch of said main female screw thread portion is P′, a γ amount of deformation of said nut-annular groove portion or said outer circumferential groove portion in the axial direction is (n+1/30)P′≦γ≦(n+5/18)P′,preferably(n+1/15)P′≦γ≦n+¼)P′, further preferably (n+1/15)P′≦γ≦(n+⅕)P′, or (n−5/18)P′≦γ≦(n−1/30)P′, preferably(n−¼)P′≦γ≦(n−1/15)P′, or further preferably (n−⅕)P′≦γ≦(n−1/15)P′, (however, n is an integral number more than 0, and γ is positive in the compressing direction and negative in the tensile direction).

13. The loosening-stop nut as set forth in any one of claims 8 through 12, wherein the cross sectional area of said nut-annular groove portion, said extending portion of said outer circumferential groove portion or said nut body is 5 through 50% of the area of a circle whose diameter is the root diameter of said main male screw thread portion.

14. The loosening-stop nut as set forth in any one of claims 8 through 13, wherein said extending portion is provided with a collar portion protruding to the peripheral portion of the outer circumferential wall.

15. The loosening-stop nut as set forth in any one of claims 8 through 14, wherein the outer diameter of said extending portion is formed to be 30 through 100% of the outer diameter of an inscribed circle that internally touches the outer edge of the cross sectional surface orthogonal to the axial direction of said nut body.

16. A method for producing a loosening-stop nut having a structure of a loosening-stop tightening means as set forth in claim 1, which is screwed in a male screw thread of a bolt and the like and tightens a member to be tightened, comprising the steps of:
(a) forming a nut-annular groove portion on the inner-circumferential wall of an extending portion formed integrally with a nut body or fixed at said nut body, and simultaneously forming a female screw thread, the pitch of which is the same as that of said male screw thread, on the inner-circumferential wall of said nut body or said extending portion, or (b) forming a nut-annular groove portion at a prescribed portion of the inner-circumferential wall of a nut and forming a nut body and an extending portion on said nut; and
forming a nut-resilient portion by deforming said extending portion at said nut-annular groove portion formed in said inner circumferential wall forming step with a prescribed load applied between the bearing surface of said nut body and the top face of said extending portion for a prescribed period of time so that, where it is assumed that the size of a pitch of said female screw thread is P′, a γ amount of deformation becomes (n+1/30)P′≦γ≦(n+5/18)P′, preferably (n+1/15)P′≦γ≦(n+¼)P′, further preferably (n+1/15)P′≦γ≦(n+⅕)P′, or (n−5/18)P′≦γ≦(n−1/30)P′, preferably (n−¼)P′≦γ≦(n−1/15)P′, or further preferably (n−⅕)P′≦γ≦(n−1/15)P′, (however, n is an integral number more than 0, and γ is positive in the compressing direction and negative in the tensile direction).

17. A method for producing a loosening-stop nut having a structure of a loosening-stop tightening means as set forth in claim 1, which is screwed in a male screw thread of a bolt and the like and tightens a member to be tightened, comprising the steps of:
forming the nut body and extending portion integrally or fixing an extending portion at the nut body and extending said extending portion coaxially with the top face of said nut body;
forming a nut-annular groove portion at a prescribed part of the inner circumferential wall of said extending portion formed integrally with said nut body or fixed at said nut body in said body forming step, forming a main female screw thread portion on the inner circumferential wall of said nut body, and simultaneously forming a sub female screw thread portion on the inner circumferential wall of said extending portion so that the phase thereof with respect to said main female screw thread portion is displaced by 12 through 100°, preferably 24 through 90°, or further preferably 24 through 72° from said nut-annular groove portion toward the top face of said extending portion.

18. A method for producing a loosening-stop nut having a structure of a loosening-stop tightening means as set forth in claim 1, which is screwed in a male screw thread of a bolt and the like and tightens a member to be tightened, comprising the steps of:
forming an extending portion, on which a nut-annular groove portion is formed, at a prescribed part of the inner circumferential wall thereof;
fixing said extending portion formed by said extending portion forming step on the top face of a nut body;
forming a female screw thread with the same pitch and phase as those of said male screw thread on the inner circumferential wall of said nut body, on which said extending portion is fixed in said extending portion fixing step, and on said inner circumferential wall of said extending portion; and
forming a nut-resilient portion by deforming said extending portion at said nut-annular groove portion with a prescribed load applied between the bearing surface of said nut body, on which said female screw thread is formed in said female screw thread forming step, and the top face of said extending portion for a prescribed period of time so that, where it is assumed that the size of a pitch of said female screw thread is P′, a γ amount of deformation becomes (n+1/30)P′≦γ≦(n+5/18)P′, preferably (n+1/15)P′≦γ≦(n+¼)P′, further preferably (n+1/15)P′≦γ≦(n+⅕)P′, or (n−5/18)P′≦γ≦(n−1/30)P′, preferably (n−¼)P′≦γ≦(n−1/15)P′, or further preferably (n−⅕)P′≦γ≦(n−1/15)P′, (however, n is an integral number more than 0, and γ is positive in the compressing direction and negative in the tensile direction).

19. A method for producing a loosening-stop nut having a structure of a loosening-stop tightening means as set forth in claim 1, which is screwed in a male screw thread of a bolt and the like and tightens a member to be tightened, comprising the steps of:
forming an extending portion having a nut-annular groove portion formed at a prescribed part of the inner circumferential wall thereof;
fixing said extending portion formed in said extending portion forming step on the top face of a nut body; and
forming a main female screw thread portion on the inner circumferential wall of said nut body on which said extending portion is fixed in said extending portion fixing step, and simultaneously forming a sub female screw thread portion on said inner circumferential wall of said extending portion so that the phase thereof with respect to said main female screw thread portion is displaced by 12 through 100°, preferably 24 through 90°, or further preferably 24 through 72° from said nut-annular groove portion toward the top face of said extending portion.

20. A method for producing a loosening-stop nut having a structure of a loosening-stop tightening means as set forth in claim 1, which is screwed in a male screw thread of a bolt and the like and tightens a member to be tightened, comprising the steps of:
forming an extending portion having a nut-annular groove portion formed at a prescribed part of the inner circumferential wall thereof, and next forming a nut-resilient portion by deforming said extending portion at said nut-annular groove portion with a prescribed load applied roughly in parallel to the axial direction of said extending portion for a prescribed period of time so that, where it is assumed that the size of a pitch of said female screw thread is P′, a γ amount of deformation becomes (n+1/30)P′≦γ≦(n+5/18)P′, preferably (n+1/15)P′≦γ≦(n+¼)P′, further preferably (n+1/15)P′≦γ≦(n+⅕)P′, or (n−5/18)P′≦γ≦(n−1/30)P′, preferably (n−¼)P′≦γ≦(n−1/15)P′, or further preferably (n−⅕)P′≦γ≦(n−1/15)P′, (however, n is an integral number more than 0, and γ is positive in the compressing direction and negative in the tensile direction);
fixing said extending portion formed in said extending portion deforming step on the top face of a nut body; and
forming a main female screw thread portion on the inner circumferential wall of said nut body on which said extending portion is fixed in said extending portion fixing step; and simultaneously forming a sub female screw thread portion on said inner circumferential wall of said extending portion so that the phase thereof with respect to said main female screw thread portion is displaced by 12 through 100°, preferably 24 through 90°, or further preferably 24 through 72° from said nut-annular groove portion toward the top face of said extending portion.
